(19) United States
(12) Patent Application Publication
(10) Pub. No.: US 2006/0087742 A1
(43) Pub. Date: Apr. 27, 2006

(54) Method of manufacturing a microlens substrate, a substrate with concave portions, a microlens substrate, a transmission screen, and a rear projection

(75) Inventor: Nobuo Shimizu, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/258,533

(22) Filed: Oct. 25, 2005

(30) Foreign Application Priority Data
Oct. 26, 2004 (JP) 2004-311590
Sep. 6, 2005 (JP) 2005-258429

(51) Int. Cl. G02B 27/10

(52) U.S. Cl. 359/619

(57) ABSTRACT

A method of manufacturing a microlens substrate provided with a plurality of convex lenses is disclosed. The method includes the steps of: preparing a substrate 6 formed of a constituent material having light transparency, a plurality of concave portions being formed in a usable area on one major surface of the substrate 6; supplying a resin material 23 having fluidity onto the one major surface of the substrate 6 on which the plurality of concave portions have been formed; solidifying the resin material 23 so that an absolute index of refraction of the solidified resin material 23 is larger than an absolute index of refraction of the constituent material of the substrate 6 with the plurality of concave portions, thereby obtaining a base substrate 2 with the plurality of convex lenses 21; supplying a material 32 for forming a light shielding layer onto one major surface of the base substrate 2 opposite to the other major surface thereof which faces the substrate 6 with the plurality of concave portions; forming the light shielding layer on the one major surface of the base substrate 2 by exposing the material 32 for forming the light shielding layer via the substrate 6 with the plurality of concave portions; and releasing the base substrate 2 from the substrate 6 with the plurality of concave portions.

### CROSS-REFERENCE TO RELATED APPLICATION

This application claims priority to Japanese Patent Application No. 2004-311590 filed Oct. 26, 2004, which is hereby expressly incorporated by reference herein in its entirety.

### FIELD OF THE INVENTION

The present invention relates to a method of manufacturing a microlens substrate, a substrate with concave portions, a microlens substrate, a transmission screen, and a rear projection.

### BACKGROUND OF THE INVENTION

In recent years, demand for a rear projection is becoming increasingly strong as a suitable display for a monitor for a home theater, a large screen television, or the like. In a transmission screen used for the rear projector, lenticular lenses are in general use. However, a conventional rear projection provided with such lenticular lenses has a problem that the vertical angle of view thereof is small although the lateral angle of view thereof is large (this is, there is a bias in the angles of view).

In order to solve such a problem, a transmission screen that uses a light diffusion element provided with a plurality of microlenses (microlens substrate) in place of a lenticular lens is proposed (for example, see JP-A-2000-321675). In order to improve contrast of an image to be projected, a black mask (light shielding layer or black matrix) is provided in such a light diffusion element (such as microlens substrate). However, light transmission (that is, a ratio of the amount of emission light with respect to the amount of light entering the light diffusion element) tends to lower extremely compared with the case where a black mask (light shielding layer or black matrix) is not provided in such a light diffusion element (microlens substrate). Further, in the case where a black mask (light shielding layer or black matrix) is not provided in such a light diffusion element, it is possible to heighten the light transmission. However, in such a case, contrast of the image to be obtained tends to lower extremely.

### SUMMARY OF THE INVENTION

It is one object of the present invention to provide a transmission screen and a rear projection which can obtain an image having excellent contrast and have excellent light use efficiency and excellent angle of view characteristics.

Further, it is another object of the present invention to provide a microlens substrate which can be appropriately applied to the manufacture of the transmission screen and rear projection described above.

Moreover, it is yet another object of the present invention to provide a method of manufacturing the microlens substrate described above efficiently.

In order to achieve the above objects, in one aspect of the present invention, the invention is directed to a method of manufacturing a method of manufacturing a microlens substrate provided with a plurality of convex lenses. The method includes the steps of:

preparing a substrate formed of a constituent material having light transparency, a plurality of concave portions being formed in a usable area on one major surface of the substrate;

supplying a resin material having fluidity onto the one major surface of the substrate on which the plurality of concave portions have been formed;

solidifying the resin material so that an absolute index of refraction of the solidified resin material is larger than an absolute index of refraction of the constituent material of the substrate with the plurality of concave portions, thereby obtaining a base substrate with the plurality of convex lenses;

supplying a material for forming a light shielding layer onto one major surface of the base substrate opposite to the other major surface thereof which faces the substrate with the plurality of concave portions;

forming the light shielding layer on the one major surface of the base substrate by exposing the material for forming the light shielding layer via the substrate with the plurality of concave portions; and

releasing the base substrate from the substrate with the plurality of concave portions.

This makes it possible to provide a method of manufacturing a microlens substrate which can be appropriately used to manufacture a transmission screen and a rear projection which can obtain an image having excellent contrast and have excellent light use efficiency and excellent angle of view characteristics.

In the method of manufacturing a microlens substrate according to the invention, it is preferable that, in the case where the absolute index of refraction of the solidified resin material is defined as n₁ and the absolute index of refraction of the constituent material of the substrate with the plurality of concave portions is defined as n₂, then n₁ and n₂ satisfy the relation: 0.01≦n₁/n₂≦0.8.

This makes it possible to further improve the contrast of the image to be obtained, the light use efficiency and the angle of view characteristics of the transmission screen and/or the rear projection to which the microlens substrate manufactured using the method of the invention is applied.

In the method of manufacturing a microlens substrate according to the invention, it is preferable that the absolute index of refraction n₁ of the solidified resin material is in the range of 1.35 to 1.9.

This makes it possible to further improve the angle of view characteristics of the transmission screen and/or the rear projection to which the microlens substrate manufactured using the method of the invention is applied.

In the method of manufacturing a microlens substrate according to the invention, it is preferable that the absolute index of refraction n₂ of the constituent material of the substrate with the plurality of concave portions is in the range of 1.2 to 1.8.

This makes it possible to further improve the contrast of the image to be obtained, and the light use efficiency of the transmission screen and/or the rear projection to which the microlens substrate manufactured using the method of the invention is applied.

In the method of manufacturing a microlens substrate according to the invention, it is preferable that the substrate with the plurality of concave portions is formed of a glass material as a main material.

This makes it possible to carry out the process to expose the material for forming a light shielding layer efficiently.

In the method of manufacturing a microlens substrate according to the invention, it is preferable that the resin material solidifying step includes the steps of: preparing a member having a flat portion; and

solidifying the resin material while pressing the resin material with the flat portion of the member.

Thus, it is possible to make a focal distance of each of the microlenses constituting the microlens substrate evener.

In the method of manufacturing a microlens substrate according to the invention, it is preferable that a plurality of spacers each having substantially the same absolute index of refraction as that of the solidified resin material are dispersed in the resin material, and in the resin material solidifying step the resin material is pressed with the flat portion of the member while the plurality of spacers are provided in the usable area on the substrate with the plurality of concave portions.

Thus, it is possible to make a focal distance of each of the microlenses constituting the microlens substrate evener.

In the method of manufacturing a microlens substrate according to the invention, it is preferable that the method further includes the step of: providing a plurality of spacers in the usable area of the substrate with the plurality of concave portions prior to the resin material solidifying step, each of the plurality of spacers having substantially the same absolute index of refraction as that of the solidified resin material, wherein in the resin material solidifying step the resin material is pressed with the flat portion of the member in a state where the spacers are being placed in the supplied resin material.

Thus, it is possible to make a focal distance of each of the microlenses constituting the microlens substrate evener.

In the method of manufacturing a microlens substrate according to the invention, it is preferable that prior to the resin material supplying step, the one major surface of the prepared substrate with the plurality of concave portions on which the plurality of concave portions have been formed is subjected to a mold releasing process.

This makes it possible to carry out the base substrate releasing step from the substrate with the plurality of concave portions smoothly while preventing defects such as crack from being generated in any microlens of the formed microlenses.

In the method of manufacturing a microlens substrate according to the invention, it is preferable that wherein the usable area of the prepared substrate with the plurality of concave portions is subjected to the mold releasing process, and at least a part of an unusable area of the prepared substrate with the plurality of concave portions other than the usable area is not subjected to the mold releasing process.

This makes it possible to, for example, remove the member that presses the surface side of the resin material on which the light shielding layer is formed from the surface of the main substrate effectively while preventing the substrate with concave portions from dropping off from the main substrate.

In the method of manufacturing a microlens substrate according to the invention, it is preferable that the usable area of the prepared substrate with the plurality of concave portions is subjected to the mold releasing process, and at least a part of an unusable area of the prepared substrate with the plurality of concave portions other than the usable area is not subjected to the mold releasing process.

This makes it possible to carry out the base substrate releasing step from the substrate with the plurality of concave portions smoothly while preventing defects such as crack from being generated in any microlens of the formed microlenses.

In the method of manufacturing a microlens substrate according to the invention, it is preferable that in the base substrate releasing step the base substrate is released from the substrate with the plurality of concave portions by cutting off the unusable area of the substrate with the plurality of concave portions and/or a portion of the base substrate corresponding to the unusable area of the substrate with the plurality of concave portions.

This makes it possible to prevent moire due to interference of light from being generated effectively.

In the method of manufacturing a microlens substrate according to the invention, it is preferable that the plurality of convex lenses constitute microlenses, and each of the microlenses has a substantially elliptic shape when viewed from above the one major surface of the base substrate.

This makes it possible to improve the angle of view characteristics further.

In another aspect of the invention, the invention is directed to a microlens substrate. The microlens substrate is manufactured using the method of manufacturing a microlens substrate provided with a plurality of convex lenses according to invention described above.

Thus, for example, it is possible to use the obtained microlens substrate as a component (microlens substrate) of a transmission screen and/or a rear projection.

In still another aspect of the invention, the invention is directed to a transmission screen. The transmission screen of the present invention includes:

a Fresnel lens formed with a plurality of concentric prisms on one major surface thereof, the one major surface of the Fresnel lens constituting an emission surface thereof; and

the microlens substrate of the invention described above, the microlens substrate being arranged on the side of the emission surface of the Fresnel lens so that one major surface thereof on which the plurality of microlenses are formed faces the Fresnel lens.

This makes it possible to provide a transmission screen which can obtain an image having excellent contrast and have excellent light use efficiency and excellent angle of view characteristics.

In yet still another aspect of the invention, the invention is directed to a rear projection. The rear projection of the invention includes the transmission screen of the invention described above.

This makes it possible to provide a transmission screen which can obtain an image having excellent contrast and have excellent light use efficiency and excellent angle of view characteristics.

### BRIEF DESCRIPTION OF THE DRAWINGS

The foregoing and other objects, features and advantages of the invention will become more readily apparent from the following detailed description of preferred embodiments of the invention which proceeds with reference to the appending drawings.

FIG. 1 is a longitudinal cross-sectional view which schematically shows a microlens substrate in a preferred embodiment according to the present invention.

FIG. 2 is a plan view of the microlens substrate shown in FIG. 1.

FIG. 3 is a longitudinal cross-sectional view which schematically shows a transmission screen provided with the microlens substrate shown in FIG. 1 in a preferred embodiment according to the present invention.

FIG. 4 is a longitudinal cross-sectional view which schematically shows a substrate provided with a plurality of concave portions of the invention.

FIG. 5 is a longitudinal cross-sectional view which schematically shows a method of manufacturing the substrate provided with a plurality of concave portions shown in FIG. 4.

FIG. 6 is a longitudinal cross-sectional view which schematically shows one example of a method of manufacturing a microlens substrate shown in FIG. 1.

FIG. 7 is a drawing which is used for explaining refraction of light when exposing photopolymer and luminous intensity distribution of the light irradiated to the photopolymer.

FIG. 8 is a drawing which schematically shows the configuration of a rear projection to which the transmission screen of the present invention is applied.

### DETAILED DESCRIPTION OF THE INVENTION

Preferred embodiments of a method of manufacturing a microlens substrate, a microlens substrate, a transmission screen, and a rear projection according to the present invention will now be described in detail with reference to the appending drawings.

In this regard, in the present invention, a “substrate” indicates a concept that includes one having a relatively large wall thickness and substantially no flexibility, sheet-shaped one, film-shaped one, and the like. Further, although application of the microlens substrate of the invention is not particularly limited, in the present embodiment, a description will be given for the case where the microlens substrate is mainly used as a component (convex lens substrate) included in a transmission screen and/or a rear projection.

First, prior to the description of a method of manufacturing a microlens substrate according to the invention, the configuration of a microlens substrate (convex lens substrate) of the invention will be described.

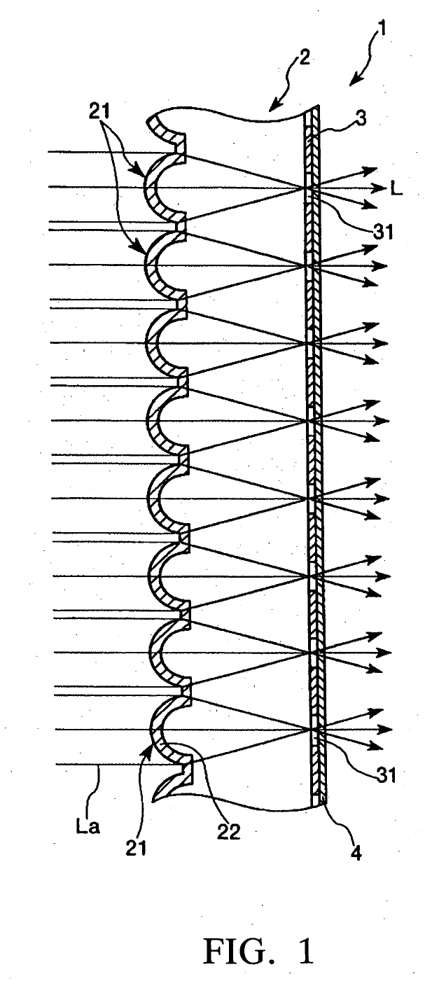

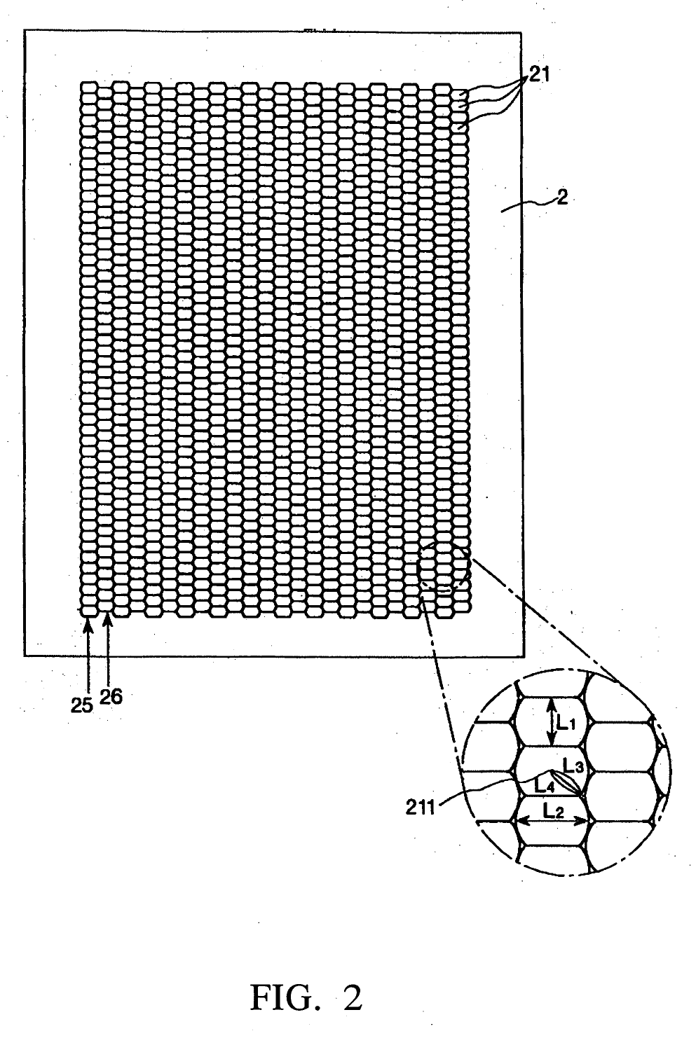

FIG. 1 is a longitudinal cross-sectional view which schematically shows a microlens substrate 1 in a preferred embodiment according to the present invention. FIG. 2 is a plan view of the microlens substrate 1 shown in FIG. 1. Now, in the following explanation using FIG. 1, for convenience of explanation, a left side and a right side in FIG. 1 are referred to as a “light incident side (or light incident surface)” and a “light emission side (or light emission surface)”, respectively. In this regard, in the following description, a “light incident side” and a “light emission side” respectively indicate a “light incident side” and a “light emission side” of light for obtaining an image light, and they do not respectively indicate a “light incident side” and a “light emission side” of outside light or the like if not otherwise specified.

The microlens substrate (convex lens substrate) 1 is a member that is included in a transmission screen 10 described later. As shown in FIG. 1, the microlens substrate 1 includes: a main substrate 2 provided with a plurality of microlenses (convex lenses) 21 in a predetermined pattern at one major surface thereof (light incident surface); a black matrix (light shielding layer) 3 formed of a material having light shielding effect at the other major surface thereof (light emission surface). Further, the microlens substrate 1 is provided with a coloring portion (outside light absorbing portion) 22 at the light incident surface thereof (that is, the light incident side of each of the microlenses 21); and a light diffusion portion 4 having a function of diffusing incident light to the microlens substrate 1 by making the incident light diffused reflection.

The main substrate 2 is generally constituted from a material having transparent. The constituent material of the main substrate 2 is not particularly limited, but the main substrate 2 is composed of a resin material as a main material. The resin material is a transparent material having a predetermined index of refraction.

As for the concrete constituent material of the main substrate 2, for example, polyolefin such as polyethylene, polypropylene, ethylene-propylene copolymer, ethylene-vinyl acetate copolymer (EVA) and the like, cyclic polyolefin, denatured polyolefin, polyvinyl chloride, polyvinylidene chloride, polystyrene, polyamide (such as nylon 6, nylon 46, nylon 66, nylon 610, nylon 612, nylon 11, nylon 12, nylon 6-12, nylon 6-66), polyimide, polyamide-imide, polycarbonate (PC), poly-(4-methylpentene-1), ionomer, acrylic resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester such as polyethylene terephthalate (PET), polybutylene terephthalate (PBT), and polycyclohexane terephthalate (PCT), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer such as aromatic polyester, fluoro resins such as polytetrafluoroethylene (PTFE), polyfluorovinylidene and the like, various thermoplastic elastomers such as styrene based elastomer, polyolefin based elastomer, polyvinylchloride based elastomer, polyurethane based elastomer, polyester based elastomer, polyamide based elastomer, polybutadiene based elastomer, trans-polyisoprene based elastomer, fluorocarbon rubber based elastomer, chlorinated polyethylene based elastomer and the like, epoxy resins, phenolic resins, urea resins, melamine resins, unsaturated polyester, silicone based resins, urethane based resins, and the like; and copolymers, blended bodies and polymer alloys and the like having at least one of these materials as a main ingredient may be mentioned. Further, in this invention, a mixture of two or more kinds of these materials may be utilized (for example, a blended resin, a polymer alloy, a laminate body comprised of two or more layers using two or more of the materials mentioned above).

The microlens substrate 1 is provided with the plurality of microlenses 21 each having a convex surface as a convex lens on the side of the light incident surface thereof from which the light is allowed to enter the microlens substrate 1. In the present embodiment, each of the microlenses 21 has a substantially elliptic shape (a flat shape or a substantial bale shape) in which a longitudinal width thereof is larger than a lateral width when viewed from above the light incident surface of the microlens substrate 1. In the case where each of the microlenses 21 has such a shape, it is possible to particularly improve the angle of view characteristics of the transmission screen 10 provided with the microlens substrate 1 while preventing disadvantage such as moiré from being generated efficiently. In particular, in this case, it is possible to improve the angle of view characteristics in both the horizontal and vertical directions of the transmission screen 10 provided with the microlens substrate 1.

In the case where the length (or pitch) of each of the microlenses 21 in a short axis (or minor axis) direction thereof is defined as L₁ (μm) and the length (or pitch) of each of the microlenses 21 in a long axis (or major axis) direction thereof is defined as L₂ (μm) when viewed from above the light incident surface of the microlens substrate 1, it is preferable that the ratio of L₁/L₂ is in the range of 0.10 to 0.99 (that is, it is preferable that L₁ and L₂ satisfy the relation: 0.10≦L₁/L₂≦0.99). More preferably it is in the range of 0.50 to 0.95, and further more preferably it is in the range of 0.60 to 0.80. By restricting the ratio of L₁/L₂ within the above range, the effect described above can become apparent.

It is preferable that the length L₁ of each of the microlenses 21 in the minor axis direction when viewed from above the light incident surface of the microlens substrate 1 is in the range of 10 to 500 μm. More preferably it is in the range of 30 to 300 μm, and further more preferably it is in the range of 50 to 100 μm. In the case where the length of each of the microlenses 21 in the minor axis direction is restricted within the above range, it is possible to obtain sufficient resolution in the image projected on the transmission screen 10 and further enhance the productivity of the microlens substrate 1 (including the transmission screen 10) while preventing disadvantage such as moiré from being generated efficiently.

Further, it is preferable that the length L₂ of each of the microlenses 21 in the major axis direction when viewed from above the light incident surface of the microlens substrate 1 is in the range of 15 to 750 μm. More preferably it is in the range of 45 to 450 μm, and further more preferably it is in the range of 70 to 150 μm. In the case where the length of each of the microlenses 21 in the major axis direction is restricted within the above range, it is possible to obtain sufficient resolution in the image projected on the transmission screen 10 and further enhance the productivity of the microlens substrate 1 (including the transmission screen 10) while preventing disadvantage such as moiré from being generated efficiently.

Moreover, it is preferable that the radius of curvature of each of the microlenses 21 in the minor axis direction thereof (hereinafter, referred to simply as “radius of curvature of the microlens 21” is in the range of 5 to 150 μm. More preferably it is in the range of 15 to 150 μm, and further more preferably it is in the range of 25 to 50 μm. By restricting the radius of curvature of the microlens 21 within the above range, it is possible to improve the angle of view characteristics of the transmission screen 10 provided with the microlens substrate 1. In particular, in this case, it is possible to improve the angle of view characteristics in both the horizontal and vertical directions of the transmission screen 10 provided with the microlens substrate 1.

Furthermore, it is preferable that the height of each of the microlenses 21 is in the range of 5 to 250 μm. More preferably it is in the range of 15 to 150 μm, and further more preferably it is in the range of 25 to 100 μm. In the case where the height of each of the microlenses 21 is restricted within the above range, it is possible to improve the light use efficiency and the angle of view characteristics particularly.

Further, in the case where the height of each of the microlenses 21 is defined as H (μm) and the length of the microlens 21 in a short axis (or minor axis) direction thereof is defined as L₁ (μm), then H and L₁ satisfy the relation: 0.90≦L₁/H≦1.9. More preferably H and L₁ satisfy the relation: 1.0≦L₁/H≦1.8, and further more preferably H and L₁ satisfy the relation: 1.2≦L₁/H≦1.6. In the case where H and L₁ satisfy such a relation, it is possible to improve the angle of view characteristics particularly while preventing moire due to interfere of light from being generated effectively.

Moreover, the plurality of microlenses 21 are arranged on the main substrate 2 in a houndstooth check manner. By arranging the plurality of microlenses 21 in this way, it is possible to prevent disadvantage such as moire from being generated effectively. On the other hand, for example, in the case where the microlenses 21 are arranged on the main substrate 2 in a square lattice manner or the like, it is difficult to prevent disadvantage such as moire from being generated sufficiently. Further, in the case where the microlenses 21 are arranged on the main substrate 2 in a random manner, it is difficult to improve the share of the microlenses 21 in a usable area in which the microlenses 21 are formed sufficiently, and it is difficult to improve light transmission into the microlens substrate 1 (light use efficiency) sufficiently. In addition, the obtained image becomes dark.

Although the microlenses 21 are arranged on the main substrate 2 in a houndstooth check manner when viewed from above one major surface of the microlens substrate 1 as described above, it is preferable that a first column 25 constituted from a plurality of microlenses 21 is shifted by a half pitch with respect to a second column 26 adjacent to the first column 25. This makes it possible to improve the angle of view characteristics particularly while preventing moire due to interfere of light from being generated effectively.

As described above, by specifying the shape of the microlens 21, the arrangement pattern of the microlenses 21, share of the microlenses 21, and the like strictly, it is possible to improve the angle of view characteristics particularly while preventing the moire due to interfere of light from being generated effectively.

Moreover, each of the microlenses 21 is formed as a convex lens which protrudes toward the light incident side thereof, and is designed so that the focal point f thereof is positioned in the vicinity of each of openings (non-light shielding portion) 31 provided on the black matrix (light shielding layer) 3. In other words, parallel light La that enters the microlens substrate 1 from a direction substantially perpendicular to the microlens substrate 1 (parallel light La from a Fresnel lens 5 described later) is condensed by each of the microlenses 21 of the microlens substrate 1, and is focused on the focal point f in the vicinity of each of openings 31 provided on the black matrix (light shielding layer) 3. In this way, since the light patting through each of the microlenses 21 focuses in the vicinity of each of the openings 31 of the black matrix 3, it is possible to enhance the light use efficiency of the microlens substrate 1 particularly. Further, since the light patting through each of the microlenses 21 focuses in the vicinity of each of the openings 31, it is possible to reduce the area of each of the openings 31.

Further, it is preferable that the ratio of an area (projected area) occupied by all the microlenses 21 in a usable area where the microlenses 21 are formed with respect to the entire usable area is in the range of 90 to 100% or more when viewed from above the light incident surface of the microlens substrate 1 (that is, a direction shown in FIG. 2). More preferably the ratio is in the range of 96 to 100%, further more preferably the ratio is in the range of 97 to 100%. In the case where the ratio of the area occupied by all the microlenses (convex lenses) 21 in the usable area with respect to the entire usable area is restricted within the above ranges, it is possible to reduce straight light passing through an area other than the area where the microlenses 21 reside, and this makes it possible to enhance the light use efficiency of the transmission screen 10 provided with the microlens substrate 1 further. In this regard, in the case where the length of one microlens 21 in a direction from the center of the one microlens 21 to the center of a non-formed area on which the four adjacent microlenses 2 including the one microlens 2 are not formed is defined as L₃ (μm) and the length between the center of the one microlens 21 and the center of the non-formed area is defined as L₄ (μm) when viewed from above the light incident surface of the microlens substrate 1, the ratio of an area (projected area) occupied by all the microlenses 21 in a usable area where the microlenses 21 are formed with respect to the entire usable area can be approximated by the ratio of the length of the line segment L₃ (μm) to the length of the line segment L₄ (μm) (that is, L₃/L₄×100 (%)) (see FIG. 2).

Further, as described above, the colored portion 22 is provided on the light incident surface of the microlens substrate 1 (that is, on the light incident side of each of the microlenses 21). The light entering the microlens substrate 1 from the light incident surface thereof can penetrate such a colored portion 22 efficiently, and the colored portion 22 has a function of preventing outside light from being reflected to the light emission side of the microlens substrate 1. By providing such a colored portion 22, it is possible to obtain a projected image having excellent contrast.

In particular, in the present invention, the colored portion 22 is one that is formed by supplying a coloring liquid (particularly, a coloring liquid having a special feature of composition) onto the main substrate 2 (will be described later). To explain this special feature in detail, the colored portion 22 is one that is formed by supplying a coloring liquid (will be described later) onto the main substrate 2 so that a coloring agent in the coloring liquid impregnates the inside of the main substrate 2 (microlenses 21). In the case where the colored portion 22 is formed in this way, it is possible to heighten adhesion of the colored portion 22 compared with the case where the colored portion 22 is laminated on the outer peripheral surface of the main substrate 2. As a result, for example, it is possible to prevent a harmful influence due to change in the index of refraction in the vicinity of the interface between the colored portion 22 and the main substrate 2 on the optical characteristics of the microlens substrate from being generated more surely.

Further, since the colored portion 22 is formed by supplying the coloring liquid onto the main substrate 2, it is possible to reduce variation in the thickness of the respective portions (in particular, the variation in the thickness that does not correspond to the surface shape of the main substrate 2). This makes it possible to prevent disadvantage such as color heterogeneity from being generated in the projected image. Moreover, although the colored portion 22 is constituted from a material containing a coloring agent, the main component thereof is generally the same as the main component of the main substrate 2 (microlens substrate 1). Therefore, a rapid change in the index of refraction or the like is hardly generated in the vicinity of the boundary between the colored portion 22 and the other non-colored portion. As a result, it is easy to design the optical characteristics of the microlens substrate 1 as a whole, and it is possible to stabilize the optical characteristics of the microlens substrate 1 and to heighten the reliability thereof.

The color density of the colored layer 22 is not particularly limited. It is preferable that the color density of the colored layer 22 indicated by Y value (D65/2° angle of view) on the basis of spectral transmittance is in the range of 20 to 85%. More preferably it is in the range of 35 to 70%. In the case where the concentration of the coloring agent in the colored portion 22 is restricted within the above ranges, it is possible to improve the contrast of the image formed by the light penetrating the microlens substrate 1 particularly. On the other hand, in the case where the color density of the colored portion 22 is below the lower limit given above, the light transmission of the incident light is lowered and the obtained image cannot have sufficient brightness. As a result, there is a possibility that the contrast of the image becomes insufficient. Further, in the case where the color density of the colored portion 22 is over the upper limit given above, it is difficult to prevent the outside light (that is, outside light entering the microlens substrate 1 from the side opposite to the light incident side) from being reflected sufficiently, and since the increasing amount of front side luminance of black indication (black luminance) becomes large when a light source is fully turned off at a bright room, there is a possibility that the effect to improve the contrast of the projected image cannot be obtained sufficiently.

The color of the colored portion 22 is not particularly limited. It is preferable that the color of the colored portion 22 is an achromatic color, particularly black as appearance using a coloring agent in which the color thereof is based on blue and red, brown or yellow is mixed therein. Further, it is preferable that light having specific wavelengths for controlling balance of light's three primary colors (RGB) of a light source is selectively absorbed in the colored portion 22 or penetrates the colored portion 22. This makes it possible to prevent the outside light from being reflected. The tone of color of the image formed from the light penetrating the microlens substrate 1 can be expressed exactly, and chromatic coordinate is widened (the width of expression of the tone of color is made to widen sufficiently), and therefore a darker black can be expressed. As a result, it is possible to improve the contrast of the image, in particular.

Moreover, the black matrix 3 is provided on the light emission surface of the main substrate 2 (the microlens substrate 1). In this case, the black matrix 3 is constituted from a material having a light shielding effect and formed in a laminated manner. By providing such a black matrix 3, it is possible to absorb outside light (which is not preferable to from a projected image) in the black matrix 3, and therefore it is possible to improve the image projected on a screen which has excellent contrast. In particular, by providing both the colored portion 22 as described above and the black matrix 3, it is possible to enhance the contrast of the image projected by the microlens substrate 1. Such a black matrix 3 is provided with a plurality of openings 31 on light path of the light penetrating each of the microlenses 21. Thus, the light condensed by each of the microlenses 21 can pass through the openings 31 of the black matrix 3 efficiently. As a result, it is possible to heighten the light use efficiency of the microlens substrate 1.

Further, it is preferable that the average thickness of the black matrix 3 is in the range of 0.3 to 8 μm. More preferably it is in the range of 0.8 to 7 μm, and further more preferably it is in the range of 1.4 to 6 μm. In the case where the average thickness of the black matrix 3 is restricted within the above ranges, it is possible to fulfill the function of the black matrix 3 (that is, the function of improving the contrast of an image to be projected) more efficiently while preventing involuntary disadvantage such as separation and crack of the black matrix 3 more surely. For example, it is possible to improve the contrast of the image projected to a screen of a transmission screen 10 provided with the microlens substrate 1.

Each of the openings 31 in the black matrix 3 generally has a shape (substantially similar shape) corresponding to the shape of each of the microlenses 21 when viewed from above one major surface of the microlens substrate 1, and is smaller than each of the microlenses 21. In other words, in the present embodiment, each of the openings 31 has a substantially elliptic shape (or a flat shape, a substantial bale shape) in which the perpendicular length is larger than the lateral width (that is, the length thereof in a long axis direction is larger than the length thereof in a short axis direction) when viewed from above the one major surface of the microlens substrate 1. Since each of the openings 31 has such a shape, it is possible to improve the contrast of an image to be projected, and to improve the angle of view characteristics particularly while preventing disadvantage such as moire from being generated efficiently.

It is preferable that the length of each of the openings 31 in the short axis direction when viewed from above one major surface of the main substrate 2 is in the range of 5 to 250 μm. More preferably it is in the range of 7 to 150 μm, and further more preferably it is in the range of 10 to 100 μm. In the case where the length of each of the openings 31 in the short axis direction is restricted within the above ranges, it is possible to improve the contrast of the obtained image to be projected particularly while improving the light use efficiency of a transmission screen 10 and/or a rear projection 300 provided with the microlens substrate 1. On the other hand, in the case where the length of each of the openings 31 in the short axis direction is below the lower limit given above, there is a possibility that it is difficult to heighten the light use efficiency sufficiently. Further, in the case where the length of each of the openings 31 in the short axis direction is above the upper limit given above, there is a possibility that it is difficult to improve the contrast of the obtained image to be projected sufficiently.

Further, it is preferable that the length of each of the openings 31 in the long axis direction when viewed from above one major surface of the main substrate 2 is in the range of 10 to 500 μm. More preferably it is in the range of 12 to 200 μm, and further more preferably it is in the range of 15 to 152 μm. In the case where the length of each of the openings 31 in the long axis direction is restricted within the above ranges, it is possible to improve the contrast of the obtained image to be projected particularly while improving the light use efficiency of a transmission screen 10 and/or a rear projection 300 provided with the microlens substrate 1. On the other hand, in the case where the length of each of the openings 31 in the long axis direction is below the lower limit given above, there is a possibility that it is difficult to heighten the light use efficiency sufficiently. Further, in the case where the length of each of the openings 31 in the long axis direction is above the upper limit given above, there is a possibility that it is difficult to improve the contrast of the obtained image to be projected sufficiently.

Moreover, in the case where the length of each of the microlenses 21 in the short axis direction (in the lateral direction thereof) is defined as L₁ (μm) and the length of each of the openings 31 in the short axis direction (in the lateral direction thereof) is defined as L₁′ (μm) when viewed from above one major surface of the microlens substrate 1, it is preferable that L₁ and L₁′ satisfy the relation: 0.1≦L₁/L₁′≦0.9. More preferably L₁ and L₁′ satisfy the relation: 0.2≦L₁/L₁′≦0.8, and further more preferably L₁ and L₁′ satisfy the relation: 0.3≦L₁/L₁′≦0.6. In the case L₁ and L₁′ satisfy the above relation, it is possible to improve the contrast of the obtained image to be projected particularly while improving the light use efficiency of a transmission screen 10 and/or a rear projection 300 provided with the microlens substrate 1.

Furthermore, in the case where the length of each of the microlenses 21 in the long axis direction (in the longitudinal direction thereof) is defined as L₂ (μm) and the length of each of the openings 31 in the long axis direction (in the longitudinal direction thereof is defined as L₂′ (μm) when viewed from above one major surface of the microlens substrate 1, it is preferable that L₂ and L₂′ satisfy the relation: 0.1≦L₁/L₂′≦0.9. More preferably L₂ and L₂′ satisfy the relation: 0.2≦L₂/L₂′≦0.8, and further more preferably L₂ and L₂′ satisfy the relation: 0.3≦L₂/L₂′≦0.6. In the case L₂ and L₂′ satisfy the above relation, it is possible to improve the contrast of the obtained image to be projected particularly while improving the light use efficiency of a transmission screen 10 and/or a rear projection 300 provided with the microlens substrate 1.

Further, a light diffusion portion 4 is provided on the light emission surface of the microlens substrate 1. The light diffusion portion 4 has a function of diffusing incident light to the microlens substrate 1 by making the incident light diffused reflection. By providing such a light diffusion portion 4, it is possible to improve the angle of view characteristics. Moreover, the light diffusion portion 4 is formed on the black matrix 3 farther than the light emission surface of the main substrate 2 (outermost portion of the microlens substrate 1 at the light emission surface thereof). In the case where the microlens substrate 1 has such a configuration, it is possible to direct the incident light into the light diffusion portion 4 to the light emission side (the direction opposite to the light incident side thereof) of the microlens substrate 1 efficiently, and this makes it possible to improve the angle of view characteristics of the transmission screen 10 particularly (that is, it is possible to particularly enlarge the angle of view which of the image to be projected to a screen of the transmission screen 10 can be viewed appropriately). In the present embodiment, the light diffusion portion 4 is constructed so that light diffusion media is dispersed into a substantially transparent material having excellent light transmission (for example, acrylic based resin, polycarbonate resin or the like). As for light diffusion media, for example, beads-shaped silica, glass, and resin may be mentioned. The average grain diameter of the light diffusion media is not particularly limited. However, it is preferable that the average grain diameter of the light diffusion media is in the range of 1 to 50 μm, and more preferably it is in the range of 2 to 10 μm.

Moreover, the thickness of the light diffusion portion 4 is not particularly limited. However, it is preferable that the thickness of the light diffusion portion 4 is in the range of 0.05 to 5 mm. More preferably it is in the range of 0.7 to 4 mm, and further more preferably it is in the range of 1.0 to 3 mm. In the case where the thickness of the light diffusion portion 4 is restricted within the above ranges, it is possible to improve the angle of view characteristics particularly while heightening the light use efficiency sufficiently. On the other hand, in the case where the thickness of the light diffusion portion 4 is below the lower limit given above, there is a possibility that the effects by providing the light diffusion portion 4 cannot be achieved sufficiently. Furthermore, in the case where the thickness of the light diffusion portion 4 is over the upper limit given above, probability (frequency) that light (that is, photon) collides with the light diffusion media tends to heighten rapidly, and thus, optical quenching occurs easily. In addition, probability that the light (photon) entering the light diffusion portion 4 returns to the light incident side of the light diffusion portion 4 again tends to heighten. As a result, there is a possibility that it is difficult to heighten the light use efficiency sufficiently.

Since the microlens substrate 1 of the invention is manufactured using the method of manufacturing a microlens substrate as will be described later, the microlens substrate 1 has excellent light use efficiency. In this regard, it is preferable that the light use efficiency of the microlens substrate 1 (that is, a ratio of the amount of emission light emitting from the light emission surface of the microlens substrate 1 with respect to the amount of light entering the microlens substrate 1 from the light incident surface thereof) is 60% or more. More preferably it is 70% or more, and further more preferably it is in the range of 80 to 95%.

Next, a transmission screen 10 provided with the microlens substrate 1 as described above will now be described.

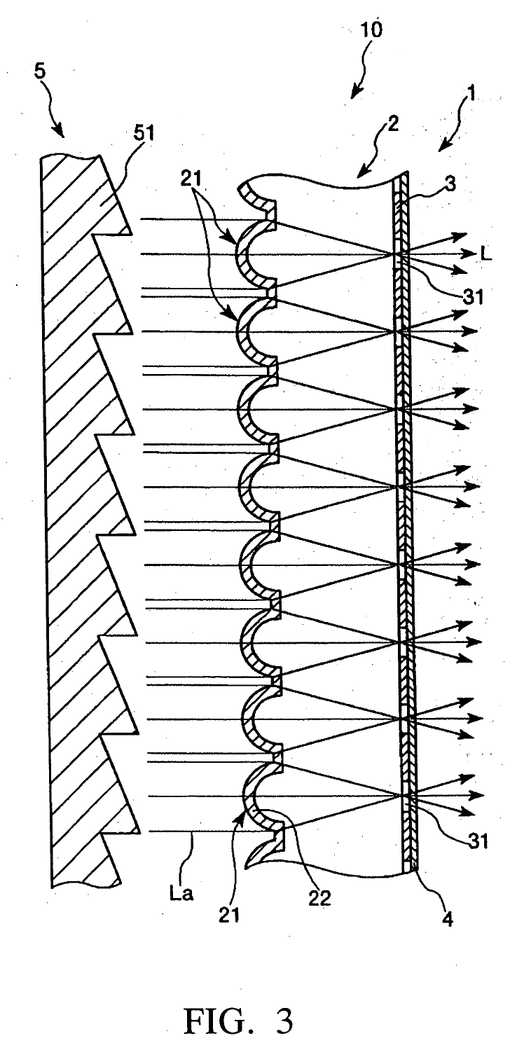

FIG. 3 is a longitudinal cross-sectional view which schematically shows a transmission screen 10 provided with the microlens substrate 1 shown in FIG. 1 in a preferred embodiment according to the present invention. Now, in the following explanation using FIG. 3, for convenience of explanation, a left side and a right side in FIG. 3 are referred to as a “light incident side (or light incident surface)” and a “light emission side (or light emission surface)”, respectively. In this regard, in the following description, a “light incident side” and a “light emission side” respectively indicate a “light incident side” and a “light emission side” of light for obtaining an image light, and they do not respectively indicate a “light incident side” and a “light emission side” of outside light or the like if not otherwise specified. As shown in FIG. 3, the transmission screen 10 is provided with a Fresnel lens 5 and the microlens substrate 1 described above. The Fresnel lens 5 is arranged on the side of the light incident surface of the microlens substrate 1 (that is, on the incident side of light for an image), and the transmission screen 10 is constructed so that the light that has been transmitted by the Fresnel lens 5 enters the microlens substrate 1.

The Fresnel lens 5 is provided with a plurality of prisms that are formed on a light emission surface of the Fresnel lens 5 in a substantially concentric manner. The Fresnel lens 5 deflects the light for a projected image from a projection lens (not shown in the drawings), and outputs parallel light La that is parallel to the perpendicular direction of the major surface of the microlens substrate 1 to the side of the light incident surface of the microlens substrate 1.

In the transmission screen 10 constructed as described above, the light from the projection lens is deflected by the Fresnel lens 5 to become the parallel light La. Then, the parallel light La enters the microlens substrate 1 from the light incident surface on which the plurality of microlenses 21 are formed to be condensed by each of the microlenses 21 of the microlens substrate 1, and the condensed light then is focused and passes through the openings 31 of the black matrix (light shielding layer) 3. At this time, the light entering the microlens substrate 1 penetrates through the microlens substrate 1 with sufficient transmittance and the light penetrating the openings 31 is then diffused, whereby an observer (viewer) of the transmission screen 10 observes (watches) the as a flat image.

Next, a description will now be given for a substrate provided with a plurality of concave portions (for forming microlenses) of the present invention which can be used suitably to manufacture the microlens substrate as described above and a method of manufacturing the same.

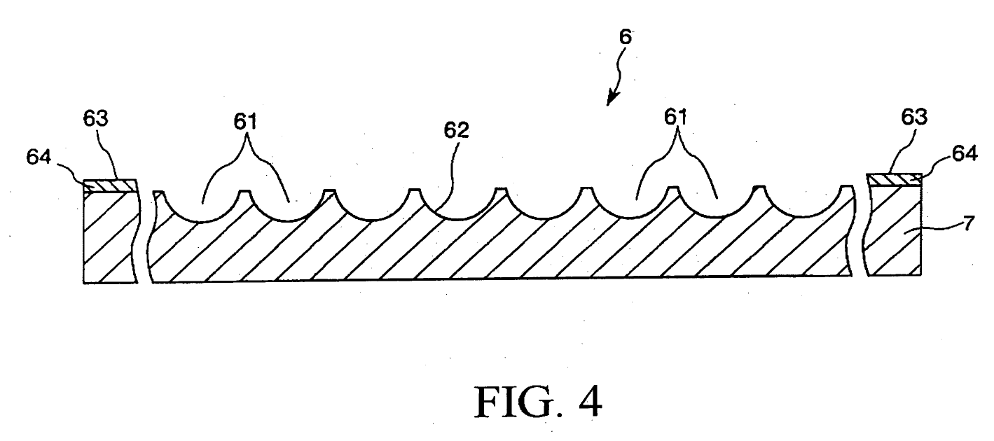

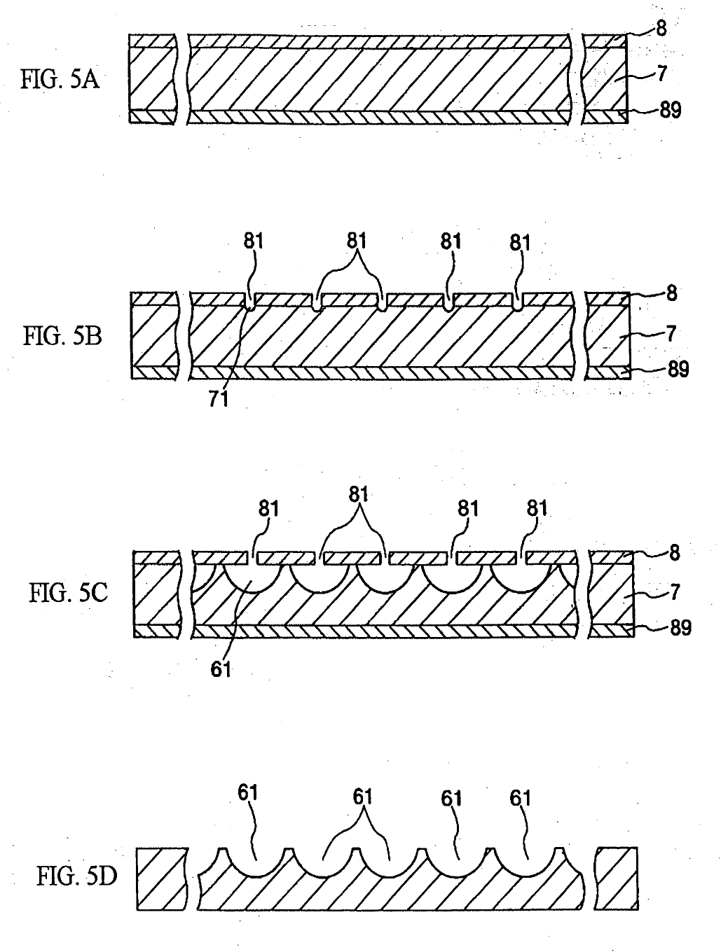

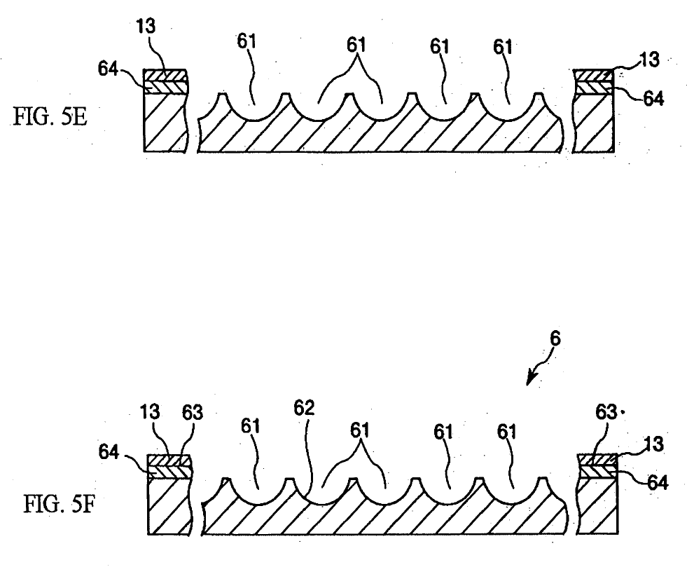

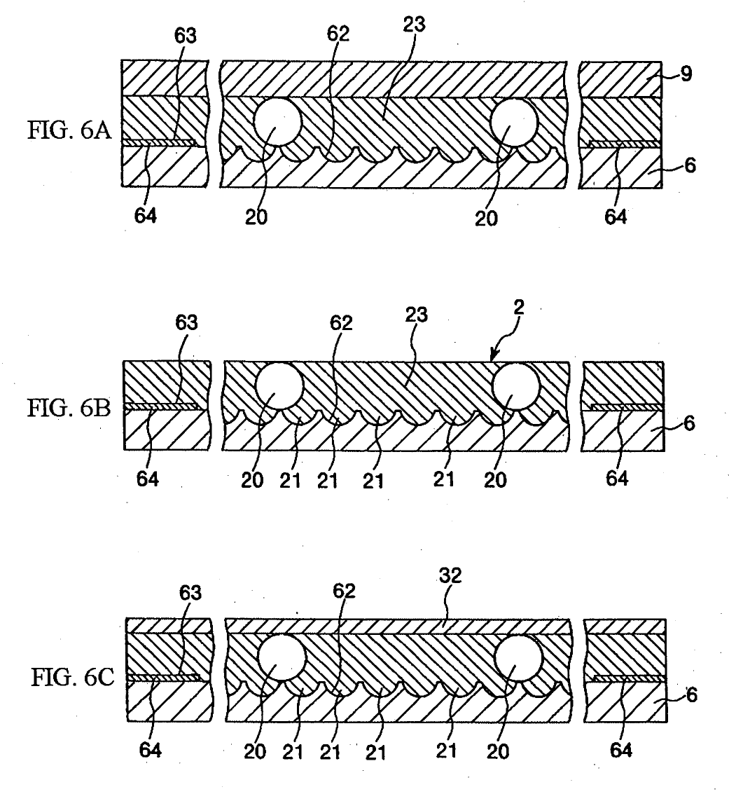

FIG. 4 is a longitudinal cross-sectional view which schematically shows a substrate 6 provided with a plurality of concave portions 61 of the invention. FIG. 5 is a longitudinal cross-sectional view which schematically shows a method of manufacturing the substrate 6 provided with a plurality of concave portions 61 shown in FIG. 4. In this regard, although a plurality of concave portions for forming microlenses 21 are actually formed on one major surface of the base substrate 7 in manufacturing the substrate 6 for manufacturing a microlens substrate 1 and a plurality of microlenses 21 (convex lenses) are actually formed on the one surface of the main substrate 2 in manufacturing the microlens substrate, in order to make the explanation understandable, a part of the substrate 6 with concave portions is shown so as to be emphasized in FIGS. 4 and 5.

The configuration of the substrate 6 provided with a plurality of concave portions 61 which can be used for manufacturing a microlens substrate 1 will first be described.

It is preferable that the substrate 6 with concave portions (for forming microlenses 21) is formed of a material having light transparency, that is, a substantially transparent material. As for the constituent material of the substrate 6 with concave portions for forming microlenses 21, for example, any material such as various metal materials, various glass materials, and various resin materials may be mentioned. As for the glass material, for example, soda-lime glass, crystalline glass, quartz glass, lead glass, potassium glass, borosilicate glass, alkali-free glass and the like may be mentioned. Further, as for the resin material, for example, various resin material including polyolefin such as polyethylene, polypropylene, ethylene-propylene copolymer, ethylene-vinyl acetate copolymer (EVA) and the like, cyclic polyolefin, denatured polyolefin, polyvinyl chloride, polyvinylidene chloride, polystyrene, polyamide (such as nylon 6, nylon 46, nylon 66, nylon 610, nylon 612, nylon 11, nylon 12, nylon 6-12, nylon 6-66), polyimide, polyamide-imide, polycarbonate (PC), poly-(4-methylpentene-1), ionomer, acrylic resin, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester such as polyethylene terephthalate (PET), polybutylene terephthalate (PBT), and polycyclohexane terephthalate (PCT), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer such as aromatic polyester, fluoro resins such as polytetrafluoroethylene (PTFE), polyfluorovinylidene and the like, various thermoplastic elastomers such as styrene based elastomer, polyolefin based elastomer, polyvinylchloride based elastomer, polyurethane based elastomer, polyester based elastomer, polyamide based elastomer, polybutadiene based elastomer, trans-polyisoprene based elastomer, fluorocarbon rubber based elastomer, chlorinated polyethylene based elastomer and the like, epoxy resins, phenolic resins, urea resins, melamine resins, unsaturated polyester, silicone based resins, urethane based resins, and the like; and copolymers, blended bodies and polymer alloys and the like having at least one of these materials as a main ingredient may be mentioned. Further, in this invention, a mixture of two or more kinds of these materials may be utilized. The glass material is preferable as for the constituent material of the substrate 6 with concave portions among these materials. The glass material generally has excellent stability of a shape thereof. For this reason, it is possible to particularly improve the stability (reliability) of the shape of each of the concave portions 61, and it is possible to improve accuracy of dimension of each of the microlenses 21 to be formed using the substrate 6 with concave portions, in particular. Further, it is also possible to heighten the reliability of the optical characteristics of the microlens substrate 1 as a lens substrate. In this way, since a glass material generally has excellent stability of a shape thereof, it is possible to improve handleability of the main substrate 2 in the method of manufacturing a microlens substrate 1 as will be described later. Further, a glass material generally has excellent transparency and excellent transmission of light. For this reason, in the case where the substrate 6 with concave portions is formed of a glass material, it is possible to form the black matrix (light shielding layer) 3 provided with the openings 31 each having a optimum size in the method of manufacturing a microlens substrate 1 as will be described later easily and surely.

The resin material (the resin material at the solidified state) constituting the main substrate 2 normally has an absolute index of refraction more than each of those of various gases (that is, atmosphere at which the microlens substrate 1 is used). It is preferable that the concrete absolute index of refraction of the resin material is in the range of 1.35 to 1.9, and more preferably it is in the range of 1.40 to 1.75. In the case where the absolute index of refraction of the resin material has a predetermined value within the above range, it is possible to further improve the angle of view characteristics of a transmission screen 10 provided with the microlens substrate 1 while keeping the light use efficiency of the transmission screen 10.

The absolute index of refraction of the constituent material of the substrate 6 with concave portions is generally larger than the absolute index of refraction of various gases (for example, air, various inert gases, and the like), and smaller than the absolute index of refraction of the resin material (solidified resin material) constituting the main substrate 2 described above. This makes it possible to irradiate photopolymer 32 with the light having suitable luminous intensity distribution in the method of manufacturing a microlens substrate 1 (will be described later), and therefore, it is possible to form the black matrix provided with the openings 31 each having a suitable size easily and surely. As a result, it is possible to improve the contrast of an image obtained by the transmission screen 10 using the microlens substrate 1, and to improve the light use efficiency and the angle of view characteristics of the transmission screen 10 and/or the rear projection 300.

The absolute index of refraction of the constituent material of the substrate 6 with concave portions is not particularly limited as long as it is smaller than the absolute index of refraction of the resin material (solidified resin material) constituting the main substrate 2. However, it is preferable that the absolute index of refraction of the constituent material of the substrate 6 with concave portions is in the range of 1.2 to 1.8, and more preferably it is in the range of 1.35 to 1.65. In the case where the absolute index of refraction of the constituent material of the substrate 6 with concave portions is restricted within the above ranges, it is possible to achieve the effects as described above further remarkably.

Further, in the case where the absolute index of refraction of the resin material (solidified resin material) constituting the main substrate 2 is defined as n₁ and the absolute index of refraction of the constituent material of the substrate 6 with concave portions is defined as n₂, it is preferable that n₁ and n₂ satisfy the relation: 0.01≦n₁/n₂≦0.8. More preferably n₁ and n₂ satisfy the relation: 0.01≦n₁/n₂≦0.4, and further more preferably n₁ and n₂ satisfy the relation: 0.01≦n₁/n₂≦0.25. In the case where n₁ and n₂ satisfy such relation, it is possible to irradiate photopolymer 32 with the light having optimum luminous intensity distribution in the method of manufacturing a microlens substrate 1 (will be described later in detail), and therefore, it is possible to form the black matrix provided with the openings 31 each having an optimum size easily and surely. As a result, it is possible to improve the contrast of an image obtained by the transmission screen 10 using the microlens substrate 1, and to further improve the light use efficiency and the angle of view characteristics of the transmission screen 10 and/or the rear projection 300.

The substrate 6 with concave portions for forming microlenses 21 has a shape in which the concave portions 61 correspond to the microlenses 21 constituting the microlens substrate 1, and is provided with a plurality of concave portions 61 for forming microlenses 21 which are arranged in a manner corresponding to the arrangement pattern of the microlenses 21 of the microlens substrate 1. Each of the concave portions 61 generally has substantially the same size of each of the microlenses 21 (the same except that each of the microlenses 21 is a convex portion, while each of the concave portions 61 is a concave portion, and that one has the mirror image relation with respect to the other), and the concave portions 61 has the same arrangement pattern as the microlenses 21.

To explain it in detail, in the present embodiment, each of the concave portions 61 (concave portions 61 for forming microlenses 21) has a substantially elliptic shape (or a flat shape, a substantial bale shape) in which the perpendicular length is larger than the lateral width (that is, the length thereof in a long axis direction is larger than the length thereof in a short axis direction) when viewed from above the one major surface of the substrate 6 with concave portions for forming microlenses 21. Since each of the concave portions 61 has such a shape, it is possible to appropriately utilize the manufacture of the microlens substrate 1 which can improve the angle of view characteristics particularly while preventing disadvantage such as moire from being generated efficiently.

Further, in the case where the length (or pitch) of each of the concave portions 61 in a short axis (or minor axis) direction thereof is defined as L₁ (μm) and the length (or pitch) of each of the concave portions 61 in a long axis (or major axis) direction thereof is defined as L₂ (μm) when viewed from above the outer peripheral surface of the substrate 6 with concave portions, it is preferable that the ratio of L₁/L₂ is in the range of 0.10 to 0.99 (that is, L₁ and L₂ satisfy the relation: 0.10≦L₁/L₂≦0.99). More preferably it is in the range of 0.50 to 0.95, and further more preferably it is in the range of 0.60 to 0.80. By restricting the ratio of L₁/L₂ within the above range, the effect described above can become apparent.

Moreover, it is preferable that the length L₁ of each of the concave portions 61 in the minor axis direction when viewed from above the outer peripheral surface of the substrate 6 with concave portions is in the range of 10 to 500 μm. More preferably it is in the range of 30 to 300 μm, and further more preferably it is in the range of 50 to 100 μm. In the case where the length of each of the concave portions 61 in the minor axis direction is restricted within the above range, it is possible to obtain sufficient resolution in the image projected on the transmission screen 10 and further enhance the productivity of the microlens substrate 1 (and the substrate 6 with concave portions) while preventing disadvantage such as moire from being generated efficiently.

Furthermore, it is preferable that the length L₂ of each of the concave portions 61 in the major axis direction when viewed from above the outer peripheral surface of the substrate 6 with concave portions is in the range of 15 to 750 μm. More preferably it is in the range of 45 to 450 μm, and further more preferably it is in the range of 75 to 150 μm. In the case where the length of each of the concave portions 61 in the major axis direction is restricted within the above range, it is possible to obtain sufficient resolution in the image projected on the transmission screen 10 and further enhance the productivity of the microlens substrate 1 (and the substrate 6 with concave portions) while preventing disadvantage such as moiré from being generated efficiently.

Further, it is preferable that the radius of curvature of each of the concave portions 61 in the minor axis direction thereof (hereinafter, referred to simply as “radius of curvature of the concave portion 61” is in the range of 5 to 150 μm. More preferably it is in the range of 15 to 150 μm, and further more preferably it is in the range of 25 to 50 μm. By restricting the radius of curvature of the concave portions 61 within the above range, it is possible to improve the angle of view characteristics of the transmission screen 10 provided with the microlens substrate 1. In particular, in this case, it is possible to improve the angle of view characteristics in both the horizontal and vertical directions of the transmission screen 10 provided with the microlens substrate 1.

Moreover, it is preferable that the depth of each of the concave portions 61 is in the range of 7 to 375 μm. More preferably it is in the range of 22 to 225 μm, and further more preferably it is in the range of 37 to 75 μm. In the case where the depth of each of the concave portions 61 is restricted within the above ranges, it is possible to improve the light use efficiency and the angle of view characteristics of the transmission screen 10 provided with the microlens substrate 1.

Furthermore, in the case where the depth of each of the concave portions 61 is defined as D (μm) and the length of each of the concave portions 61 in a short axis direction is defined as L₁ (μm), it is preferable that D and L₁ satisfy the relation: 0.02≦L₁/D≦50. More preferably D and L₁ satisfy the relation: 0.1≦L₁/D≦1.4, and further more preferably D and L₁ satisfy the relation: 0.5≦L₁/D≦1.0. In the case where D and L₁ satisfy such relation as described above, it is possible to improve the angle of view characteristics of the microlens substrate 1 to be manufactured particularly while preventing moire due to interfere of light from being generated effectively.

Further, the plurality of concave portions 61 are arranged on the outer peripheral surface of the substrate 6 with concave portions in a houndstooth check manner. By arranging the plurality of concave portions 61 in this way, it is possible to prevent disadvantage such as moire from being generated effectively. On the other hand, for example, in the case where the concave portions 61 are arranged on the outer peripheral surface of the substrate 6 with concave portions in a square lattice manner or the like, it is difficult to prevent disadvantage such as moire from being generated sufficiently. Further, in the case where the concave portions 61 are arranged on the outer peripheral surface of the substrate 6 with concave portions in a random manner, it is difficult to improve the share of the concave portions 61 in a usable area in which the concave portions 61 are formed sufficiently, and it is difficult to improve light transmission into the microlens substrate and/or the substrate with concave portions (that is, light use efficiency) sufficiently. In addition, the obtained image becomes dark.

Moreover, although the concave portions 61 are arranged on the substrate 6 with concave portions in a houndstooth check manner when viewed from above the one major surface of the substrate 6 with concave portions as described above, it is preferable that a first column of concave portions 61 is shifted by a half pitch of each of the concave portions 61 in a short axis direction thereof with respect to a second column of concave portions 61 which is adjacent to the first column of concave portions 61 when viewed from above the one major surface of the substrate 6 with concave portions. This makes it possible to improve the angle of view characteristics particularly while preventing moire due to interfere of light from being generated effectively.

In this regard, in the above explanation, it has been described that each of the concave portions 61 has substantially the same shape (size) as that of each of the microlenses 21 with which the microlens substrate 1 is provided, and the concave portions 61 have substantially the same arrangement pattern as that of the microlenses 21. However, for example, in the case where the constituent material of the main substrate 2 of the microlens substrate 1 tends to contract easily (that is, in the case where the resin material constituting the main substrate 2 is contracted by means of solidification or the like), the shape (and size), share or the like with respect to each of the microlenses 21 with which the microlens substrate 1 is provided an the concave portions 61 with which the substrate 6 with concave portions (for forming microlenses 21) is provided may be different from each other in view of the percentage of contraction or the like.

Further, in the present embodiment, a mold releasing processed portion 62 that has been subjected to a mold releasing process is provided in the vicinity of the surface of the region (usable area) where the concave portions 61 are formed of the substrate 6 with concave portions, while a mold releasing non-processed portion 63 that has never been subjected to a mold releasing process is provided in the region (unusable area) where the concave portions are not formed. In this way, by providing both the mold releasing processed portion 62 and the mold releasing non-processed portion 63, for example, it is possible to remove a member (flat plate 9) for pressing the surface of a resin material 23 on which a light shielding layer (black matrix 3) is formed from the surface of the main substrate 2 efficiently while preventing the substrate 6 with concave portions from dropping off from the main substrate 2 after forming the main substrate 2 (that is, after solidifying the resin material 23) in the method of manufacturing a microlens substrate 1 (will be described later in detail). Moreover, in the present embodiment, the mold releasing non-processed portion 63 is formed of an adhering element 64. Thus, it is possible to prevent the substrate 6 with concave portions from dropping off from the main substrate 2 when removing the member (flat plate 9) for pressing the surface of a resin material 23 on which a light shielding layer (black matrix 3) is formed from the surface of the main substrate 2 after forming the main substrate 2 (that is, after solidifying the resin material 23) efficiently.

Next, the method of manufacturing the substrate 6 with concave portions according to the present invention will now be described with reference to FIG. 5. In this regard, although a plurality of concave portions 61 for forming microlenses 21 are actually formed in a base substrate 7, in order to make the explanation understandable, a part of the base substrate 7 is shown so as to be emphasized in FIG. 5.

First, a base substrate 7 is prepared in manufacturing the substrate 6 with concave portions.

It is preferable that a base material having a substantially column shape or substantially cylinder shape is used for the base substrate 7. Further, it is also preferable that a base material with a surface cleaned by washing or the like is used for the base substrate 7.

Although soda-lime glass, crystalline glass, quartz glass, lead glass, potassium glass, borosilicate glass, alkali-free glass and the like may be mentioned as for a constituent material for the base substrate 7, soda-lime glass and crystalline glass (for example, neoceram or the like) are preferable among them. By the use of soda-lime glass, crystalline glass or alkali-free glass, it is possible to improve the stability of a shape thereof and transmission of light as described above, and it is easy to process the material for the base substrate 7. In addition, it is advantageous from the viewpoint of a manufacturing cost of the substrate 6 with concave portions because soda-lime glass or crystalline glass is relatively inexpensive.

<A1> As shown in FIG. 5A, a mask (layer) 8 is formed on the surface of the prepared base substrate 7 (mask formation process). Then, a back surface protective film 89 is formed on the back surface of the base substrate 7 (that is, the surface side opposite to the surface on which the mask 8 is formed). Needless to say, the mask 8 and the back surface protective film 89 may be formed simultaneously.

The constituent material of the mask 8 is not particularly limited, for example, metals such as Cr, Au, Ni, Ti, Pt, and the like, metal alloys containing two or more kinds of metals selected from these metals, oxides of these metals (metal oxides), silicon, resins, and the like may be mentioned.

Further, the mask 8 may be, for example, one having a substantially even composition, or a laminated structure by a plurality of layers.

As described above, the structure of the mask 8 is not particularly limited, and it is preferable that the mask 8 has a laminated structure constructed from a layer formed of chromium as a main material and a layer formed of chromium oxide as a main material. The mask 8 having such a structure has excellent stability with respect to various echants having various structures (that is, it is possible to protect the base substrate 7 more surely at an etching process (as will be described later)), and it is possible to form the openings (initial holes 81) each having a desired shape easily and surely by means of irradiation with laser beams or the like as will be described later. Further, in the case where the mask 8 has such a structure as described above, a solution containing ammonium hydrogen difluoride (NH₄HF₂), for example, may be appropriately used as an etchant at the etching process (described later). Since a solution containing ammonium hydrogen difluoride is not poison, it is possible to prevent its influence on human bodies during work and on the environment more surely. Moreover, the mask 8 having such a structure makes it possible to reduce internal stress of the mask 8 effectively, and such a mask 8 has excellent adhesion (that is, adhesion of the mask 8 to the base substrate 7 at the etching process, in particular) to the base substrate 7, in particular. For these reasons, by using the mask 8 having the structure described above, it is possible to form concave portions 61 each having a desired shape easily and surely.

The method of forming the mask 8 is not particularly limited. In the case where the mask 8 is constituted from any of metal materials (including metal alloys) such as Cr and Au or metal oxides such as chromium oxide, the mask 8 can be suitably formed by means of an evaporation method, a sputtering method, or the like, for example. On the other hand, in the case where the mask 8 is formed of silicon, the mask 8 can be suitably formed by means of a sputtering method, a CVD method, or the like, for example.

Although the thickness of the mask 8 also varies depending upon the material constituting the mask 8, it is preferable that the thickness of the mask 8 is in the range of 0.01 to 2.0 μm, and more preferably it is in the range of 0.03 to 0.2 μm. If the thickness of the mask 8 is below the lower limit given above, there may be a possibility to deform the shapes of the initial holes (openings) 81 formed at the initial hole formation process (or openings formation process, which will be described later) depending upon the constituent material of the mask 8 or the like. In addition, there is a possibility that sufficient protection for the masked portion of the base substrate 7 cannot be obtained during a wet etching process at the etching step (described later). On the other hand, if the thickness of the mask 8 is over the upper limit given above, in addition to the difficulty in formation of the initial holes 81 that penetrate the mask 8 at the initial hole formation process (described later), there will be a case in which the mask 8 tends to be easily removed due to internal stress thereof depending upon the constituent material or the like of the mask 8 depending upon the constituent material of the mask 8 or the like.

The back surface protective film 89 is provided for protecting the back surface of the base substrate 7 at the subsequent processes. Erosion, deterioration or the like of the back surface of the base substrate 7 can be suitably prevented by means of the back surface protective film 89. Since the back surface protective film 89 has, for example, the same configuration as that of the mask 8, it may be provided in a manner similar to the formation of the mask 8 simultaneously with the formation of the mask 8.

<A2> Next, as shown in FIG. 5B, the plurality of initial holes 81 that will be utilized as mask openings at the etching process (described later) are formed in the mask 8 in a random manner (initial hole formation process). The method of forming the initial holes 81 is not particularly limited, but it is preferable that the initial holes 81 are formed by the physical method or the irradiation with laser beams. This makes it possible to form the initial holes 81 each having a desired shape, which are arranged in a desired pattern, easily and accurately. As a result, it is possible to control the shape of each of the concave portions 61, the arrangement pattern, or the like more surely. Further, by forming the initial holes 81 by means of the irradiation with laser, it is possible to manufacture the substrate 6 with concave portions at high productivity. In particular, the concave portions can be easily formed on a relatively large-sized substrate.

Further, in the case where the initial holes 81 are formed by means of the irradiation with laser beams, the kind of laser beam to be used is not particularly limited, but a ruby laser, a semiconductor laser, a YAG laser, a femtosecond laser, a glass laser, a YVO₄ laser, a Ne—He laser, an Ar laser, a carbon dioxide laser, an excimer laser or the like may be mentioned. Moreover, a waveform of a laser such as SHG (second-harmonic generation), THG (third-harmonic generation), FHG (fourth-harmonic generation) or the like may be utilized.

When the initial holes 81 are formed in the mask 8, as shown in FIG. 5B, the initial concave portions 71 may also be formed in the base substrate 7 by removing parts of the surface of the base substrate 7 in addition to the initial holes 81. This makes it possible to increase contact area of the base substrate 7 with the etchant when subjecting the base substrate 7 with the mask 8 to the etching process (described later), whereby erosion can be started suitably. Further, by adjusting the depth of each of the initial concave portions 71, it is also possible to adjust the depth of the concave portions 61 (that is, the maximum thickness of the lens (microlens 21)). Although the depth of each of the initial concave portions 71 is not particularly limited, it is preferable that it is 5.0 μm or less, and more preferably it is in the range of about 0.01 to 0.5 μm. In the case where the formation of the initial holes 81 is carried out by means of the irradiation with laser beams, it is possible to surely reduce variation in the depth of each of the plurality of initial concave portions 71 formed together with the initial holes 81. This makes it possible to reduce variation in the depth of each of the concave portions 61 constituting a substrate 6 with concave portions, and therefore it is possible to reduce variation in the size and shape of each of the microlenses 21 in the microlens substrate 1 obtained finally. As a result, it is possible to reduce variation in the diameter, the focal distance, and the thickness of the lens of each of the microlenses 21, in particular.

The shape and size of each of the initial holes 81 to be formed at the present process is not particularly limited. The shape of each of the initial holes 81 is a substantially circular shape. In the case where each of the initial holes 81 is a substantially circular shape, it is preferable that the diameter of each of the initial holes 81 is in the range of 0.8 to 20 μm. More preferably it is in the range of 1.0 to 10 μm, and further more preferably it is in the range of 1.5 to 4 μm. In the case where the diameter of each of the initial holes 81 is restricted within the above ranges, it is possible to form the concave portions 61 each having the shape as described above at an etching process (will be described later) surely. On the other hand, in the case where each of the initial holes 81 is a flat shape such as a substantially elliptic shape, it is possible to substitute the length thereof in the short axis direction (that is, width thereof) for the diameter thereof. Namely, in the case where each of the initial holes 81 to be formed at the present process is the substantially elliptic shape, the width of each of the initial holes 81 (the length in the short axis direction) is not particularly limited, but the width of each of the initial holes 81 is in the range of 0.8 to 20 μm. More preferably it is in the range of 1.0 to 10 μm, and further more preferably it is in the range of 1.5 to 4 μm. In the case where the width of each of the initial holes 81 is restricted within the above ranges, it is possible to form the concave portions 61 each having the shape as described above at an etching process (will be described later) surely.

Further, in the case where each of the initial holes 81 to be formed at the present process is the substantially elliptic shape, the length of each of the initial holes 81 (the length in the long axis direction) is not particularly limited, but the width of each of the initial holes 81 is in the range of 0.9 to 30 μm. More preferably it is in the range of 1.5 to 15 μm, and further more preferably it is in the range of 2.0 to 6 μm. In the case where the width of each of the initial holes 81 is restricted within the above ranges, it is possible to form the concave portions 61 each having the shape as described above at an etching process (will be described later) more surely.

Further, other than by means of the irradiation with laser beams, the initial holes 81 may be formed in the formed mask 8 by, for example, previously arranging foreign objects on the base substrate 7 with a predetermined pattern when the mask 8 is formed on the base substrate 7, and then forming the mask 8 on the base substrate 7 with the foreign objects to form defects in the mask 8 by design so that the defects are utilized as the initial holes 81.

<A3> Next, as shown in FIG. 5C, a large number of concave portions 61 are formed in the base substrate 7 in a random manner by subjecting the base substrate 7 to the etching process using the mask 8 in which the initial holes 81 are formed (etching process). The etching method is not particularly limited, and as for the etching method, a wet etching process, a dry etching process and the like may be mentioned, for example. In the following explanation, the case of using the wet etching process will be described as an example.

By subjecting the base substrate 7 covered with the mask 8 in which the initial holes 81 are formed to the wet etching process, as shown in FIG. 5C, the base substrate 7 is eroded from the portions where no mask 8 is present, whereby a large number of concave portions 61 are formed in the base substrate 7. As mentioned above, since the initial holes 81 formed in the mask 8 are arranged in a houndstooth check manner, the concave portions 61 to be formed are also arranged on the surface of the base substrate 7 in a houndstooth check manner.

Further, in the present embodiment, the initial concave portions 71 are formed on the surface of the base substrate 7 when the initial holes 81 are formed in the mask 8 at step <A2>. This makes the contact area of the base substrate 7 with the etchant increase during the etching process, whereby erosion can be made to start suitably. Moreover, the concave portions 61 can be formed suitably by employing the wet etching process. In the case where an etchant containing, for example, ammonium hydrogen difluoride is utilized for an etchant, the base substrate 7 can be eroded more selectively, and this makes it possible to form the concave portions 61 suitably.

In the case where the mask 8 is mainly constituted from chromium (that is, the mask 8 is formed of a material containing Cr as a main material thereof), a solution of ammonium hydrogen difluoride is particularly suited as a hydrofluoric acid-based etchant. Since a solution containing ammonium hydrogen difluoride is not poison, it is possible to prevent its influence on human bodies during work and on the environment more surely. Further, in the case where the solution of ammonium hydrogen difluoride is used as an etchant, for example, hydrogen peroxide may be contained in the etchant. This makes it possible to accelerate the etching speed.

Further, the wet etching process can be carried out with simpler equipment than that in the dry etching process, and it allows the processing for a larger number of substrates 7 at a time. This makes it possible to enhance productivity of the substrate 6 with concave portions, and it is possible to provide the substrate 6 with concave portions at a lower cost.

<A4> Next, the mask 8 is removed as shown in FIG. 5D (mask removal process). At this time, the back surface protective film 89 is also removed along with the mask 8. In the case where the mask 8 is constituted from the laminated structure constructed from the layer formed of chromium as a main material and the layer formed of chromium oxide as a main material as described above, the removal of the mask 8 can be carried out by means of an etching process using a mixture of ceric ammonium nitrate and perchloric acid, for example.

<A5> Next, as shown in FIG. 5E, the adhering element 64 to which a separating sheet 13 is attached is applied to the unusable area where the concave portions 61 are not formed in the base substrate 7 (an arean unusable with respect to the usable area where the plurality of concave portions 61 are formed). The adhering element 64 is mainly formed of an adhesive, and the both major surfaces thereof have a function of being closely contact with (bonding) adherends. As for the adhesive, for example, an acrylic based adhesive, a polyester based adhesive, a urethane based adhesive, a rubber based adhesive and the like may be mentioned.

The surface of the separating sheet 13 opposite to the adhering element 64 is formed of a material having mold releasing ability (mold releasing agent), and it is possible to release the separating sheet 13 from the adhering element 64 with relatively small force as needed. As for the mold releasing agent, for example, silicone based resin such as alkylpolysiloxane, fluorine based resin such as polytetrafluoroethylene, various waxes, alkyd resin, polyester resin, acryl resin, cellulose resin, silylate materials by sililating agent such as hexamethyldisilazane ([(CH₃)₃Si]₂NH) and the like may be mentioned.

<A6> Then, the surface of the base substrate 7 on which the concave portions 61 are provided is subjected to a mold releasing process (see FIG. 5F). Thus, the substrate 6 with concave portions (more specifically, the substrate 6 with concave portions to which the separating sheet 13 is attached) is obtained. By subjecting the substrate 6 with concave portions to such a mold releasing process, it is possible to remove the substrate 6 with concave portions from the microlens substrate 1 easily while preventing defects such as crack from being generated in the microlenses 21 of the microlens substrate 1 sufficiently in the method of manufacturing a microlens substrate 1 (will be described later in detail). In particular, in the present embodiment, the base substrate 7 is subjected to the mold releasing process while the adhering element 64 to which the separating sheet 13 is attached is applied to the unusable area where the concave portions 61 are not formed. For this reason, the mold releasing non-processed portion 63 that has never been subjected to a mold releasing process is provided in the unusable area. Thus, for example, it is possible to remove a member (flat plate 9) for pressing the surface of a resin material 23 on which a light shielding layer (black matrix 3) is formed from the surface of the main substrate 2 efficiently while preventing the substrate 6 with concave portions from dropping off from the main substrate 2 after forming the main substrate 2 (that is, after solidifying the resin material 23) in the method of manufacturing a microlens substrate 1 (will be described later in detail).

As for the mold releasing process, formation of a film formed of a material having mold release ability, for example, silicone based resin such as alkylpolysiloxane, fluorine based resin such as polytetrafluoroethylene, surface treatment by means of silylate materials by sililating agent such as hexamethyldisilazane ([(CH₃)₃Si]₂NH), surface treatment by means of fluorine based gas or the like may be mentioned.

As a result of the processing in the above, as shown in FIGS. 5F and 4, a substrate 6 with concave portions in which a large number of concave portions 61 are formed in the base substrate 7 in a houndstooth check manner is obtained.

The method of forming the plurality of concave portions 61 on the surface of the base substrate 7 in a houndstooth check manner is not particularly limited. In the case where the concave portions 61 are formed by means of the method mentioned above, that is, the method of forming the concave portions 61 in the base substrate 7 by forming the initial holes 81 in the mask 8 by means of the irradiation with laser beams and then subjecting the base substrate 7 to the etching process using the mask 8, it is possible to obtain the following effects.

Namely, by forming the initial holes 81 in the mask 8 by means of the irradiation with laser beams, it is possible to form openings (initial holes 81) in a predetermined pattern in the mask 8 easily and inexpensively compared with the case of forming the openings in the mask 8 by means of the conventional photolithography method. This makes it possible to enhance productivity of the substrate 6 with concave portions, whereby it is possible to provide the substrate 6 with concave portions at a lower cost.

Further, according to the method as described above, it is possible to carry out the processing for a large-sized substrate easily. Also, according to the method, in the case of manufacturing such a large-sized substrate, there is no need to bond a plurality of substrates as the conventional method, whereby it is possible to eliminate the appearance of seams of bonding. This makes it possible to manufacture a high quality large-sized substrate 6 with concave portions for forming microlenses 21 (that is, microlens substrate 1) by means of a simple method at a low cost.

Further, in the case of forming the initial holes 81 by means of the irradiation of laser beams, it is possible to control the shape and size of each of the initial holes 81 to be formed, arrangement thereof, and the like easily and surely.

Next, a method of manufacturing the microlens substrate 1 using the substrate 6 with concave portions will now be described.

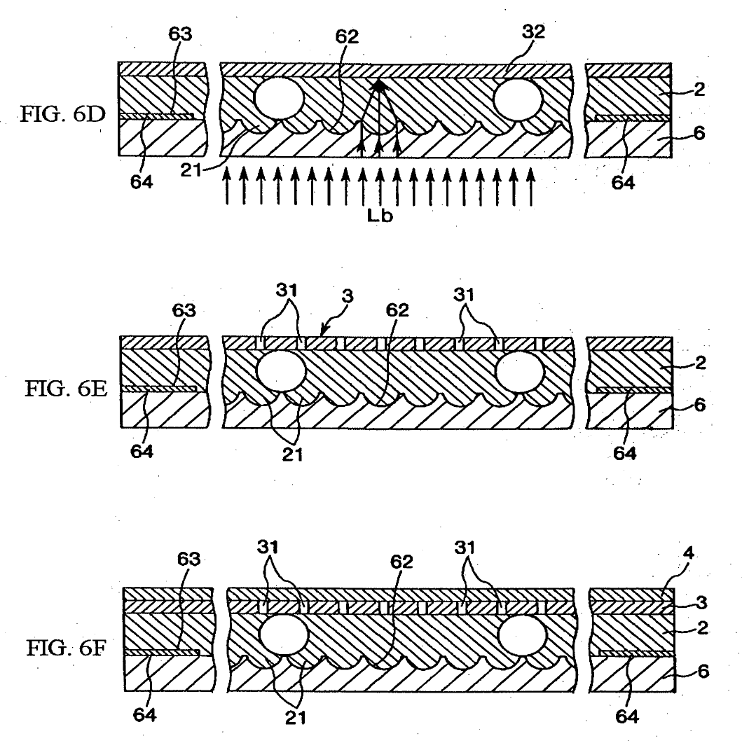

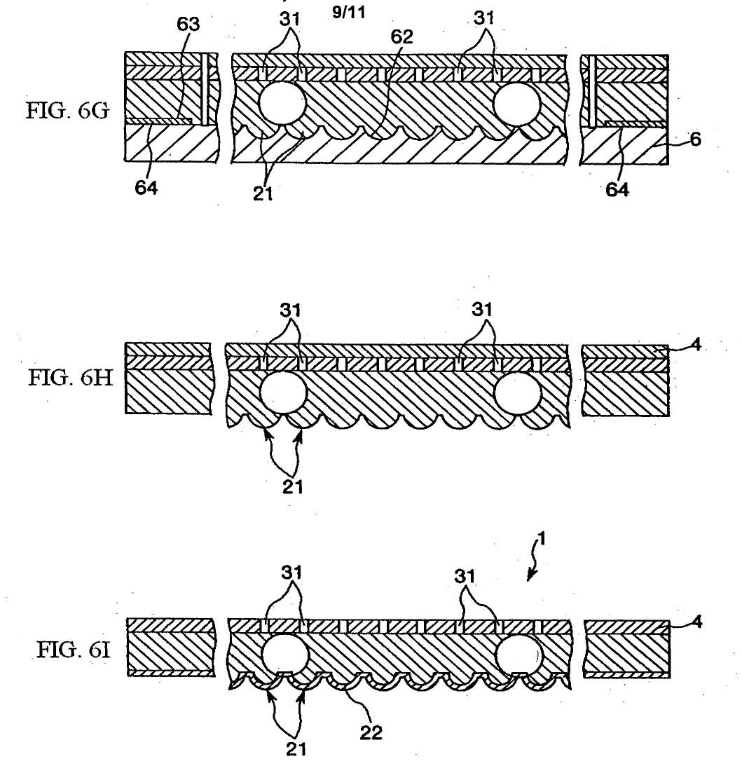

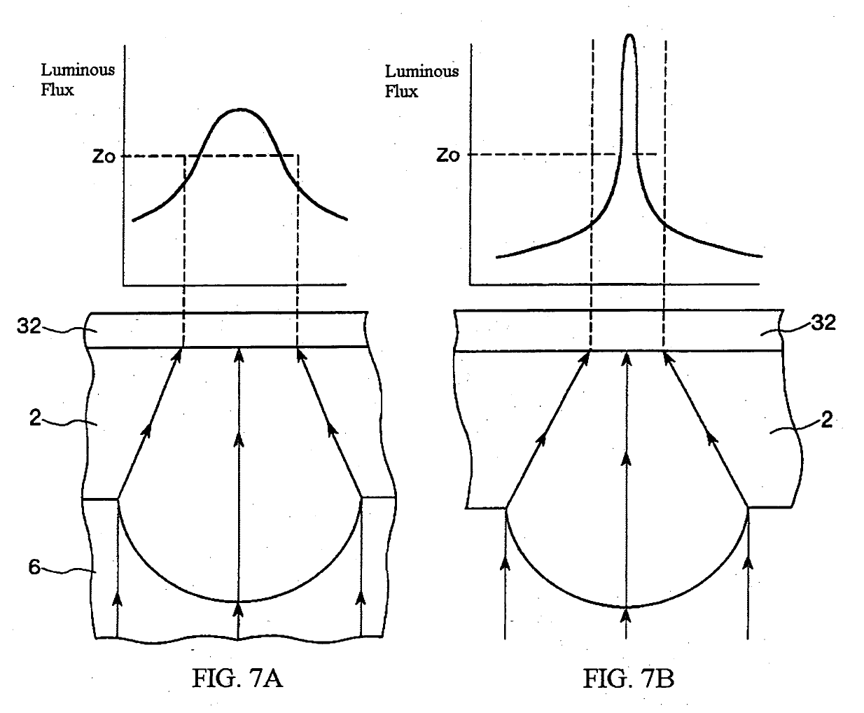

FIG. 6 is a longitudinal cross-sectional view which schematically shows one example of a method of manufacturing the microlens substrate 1 shown in FIG. 1. FIG. 7 is a drawing which is used for explaining refraction of light when exposing photopolymer and luminous intensity distribution of the light irradiated to the photopolymer. Now, in following explanations using FIG. 6, for convenience of explanation, a lower side and an upper side in FIG. 6 are referred to as “light incident side” and “light emission side”, respectively.

<B1> As shown in FIG. 6A, a resin material 23 having fluidity (for example, a resin material 23 at a softened state, a non-polymerized (uncured) resin material 23) is supplied to the surface of the substrate 6 with concave portions for forming microlenses 21 on which the concave portions 61 are formed at the state where the separating sheet 13 has already been removed, and the resin material 23 is then pressed by means of a flat plate 9. In particular, in the present embodiment, the resin material 23 is pressed (or pushed) by means of the flat plate 9 while spacers 20 are provided between the substrate 6 with concave portions and the flat plate 9. Thus, it is possible to control the thickness of the formed microlens substrate 1 more surely, and this makes it possible to control the focal points of the respective microlenses 21 in the microlens substrate 1 finally obtained more surely. In addition, it is possible to prevent disadvantage such as color heterogeneity from being generated more efficiently.

Each of the spacers 20 is formed of a material having an index of refraction nearly equal to that of the resin material 23 (the resin material 23 at a solidified state). By using the spacers 20 formed of such a material, it is possible to prevent the spacers 20 from having a harmful influence on the optical characteristics of the obtained microlens substrate 1 even in the case where the spacers 20 are arranged in portions in each of which any concave portion 61 of the substrate 6 with concave portions is formed. This makes it possible to provide a relatively large number of spacers 20 over the entire usable area on one major surface of the substrate 6 with concave portions. As a result, it is possible to get rid of the influence due to flexure of the substrate 6 with concave portions and/or the flat plate 9, or the like efficiently, and this makes it possible to control the thickness of the obtained microlens substrate 1 more surely.

Although the spacers 20 are formed of the material having an index of refraction nearly equal to that of the resin material 23 (the resin material 23 at a solidified state) as described above, more specifically, it is preferable that the absolute value of the difference between the absolute index of refraction of the constituent material of the spacer 20 and the absolute index of refraction of the resin material 23 at a solidified state is 0.20 or less, and more preferably it is 0.10 or less. Further more preferably it is 0.20 or less, and most preferably the spacer 20 is formed of the same material as that of the resin material 23 at a solidified state.

The shape of each of the spacers 20 is not particularly limited. It is preferable that the shape of the spacer 20 is a substantially spherical shape or a substantially cylindrical shape. In the case where each of the spacers 20 has such a shape, it is preferable that the diameter of the spacer 2o is in the range of 10 to 300 μm, and more preferably it is in the range of 30 to 200 μm. Further more preferably, it is in the range of 30 to 170 μm.

In this regard, in the case of using the spacers 20 as described above, the spacers 20 may be provided between the substrate 6 with concave portions and the flat plate 9 when solidifying the resin material 23. Thus, the timing to supply the spacers 20 is not particularly limited. Further, for example, a resin material 23 in which the spacers 20 are dispersed in advance may be utilized as a resin to be supplied onto the surface of the substrate 6 with concave portions on which the concave portions 61 are formed, or the resin material 23 may be supplied thereon while the spacers 20 are provided on the surface of the substrate 6 with concave portions. Alternatively, the spacers 20 may be supplied onto the surface of the substrate 6 with concave after supplying the resin material 23 thereto.

Further, the surface of the flat plate 9 for pressing the resin material 23 may be subjected to the mold releasing process as described above. This makes it possible to remove the flat plate 9 from the surface of the main substrate 2 efficiently while preventing the substrate 6 with concave portions from dropping off from the main substrate 2 at the following steps.

<B2> Next, the resin material 23 is solidified (in this regard, including hardened (polymerized)), and then the flat plate 9 is removed (see FIG. 6B). In this way, the main substrate 2 provided with the plurality of microlenses 21 (in particular, microlenses 21 which satisfy the conditions as described above such as shape, arrangement and the like) constituted from the resin material 23 filled in the plurality of concave portions 61 each of which serves as a convex lens is obtained. In the case where the solidification of the resin material 23 is carried out by being hardened (polymerized), the method thereof is not particularly limited, and it is appropriately selected according to the kind of the resin. For example, irradiation with light such as ultraviolet rays, heating, electron beam irradiation, or the like may be mentioned.

<B3> Next, a process that a black matrix (light shielding layer) 3 is formed on the light emission surface of the main substrate 2 manufactured as described above will be described.

In the invention, the formation of the light shielding layer is carried out using a process in which a material for forming a light shielding layer is supplied onto one major surface of the base substrate 2 and the material for forming the light shielding layer is then exposed. The material for forming the light shielding layer may be any one as long as it includes a component having photosensitivity. In the following explanation, it will be described that a positive type photopolymer 32 is used as the material for forming the light shielding layer.

First, as shown in FIG. 6C, a positive type photopolymer 32 having light shielding (blocking) effect is supplied onto the light emission surface of the main substrate 2. As the method of supplying the positive type photopolymer 32 onto the light emission surface of the main substrate 2, for example, various types of coating methods such as a dip coat method, a doctor blade method, a spin coat method, a blush coat method, a spray coating, an electrostatic coating, an electrodeposition coating, a roll coater, and the like can be utilized. The positive type photopolymer 32 may be constituted from a resin having light shielding (blocking) effect, or may be one in which a material having light shielding (blocking) effect is dispersed or dissolved to a resin material having low light shielding (blocking) effect. Heat treatment such as a pre-bake process, for example, may be carried out after supplying the positive type photopolymer 32 if needed.

<B4> Next, as shown in FIG. 6D, light Lb for exposure is irradiated to the main substrate 2 in a direction perpendicular to the light incident surface of the main substrate 2 via the substrate 6 with concave portions. The irradiated light Lb for exposure is refracted and condensed by entering each of the microlenses 21. By condensing the irradiated light Lb, the positive type photopolymer 32 at the portion where the condensed light having large luminous intensity (luminous flux) is irradiated is exposed, and the positive type photopolymer 32 corresponding to portions other than the portion irradiated with the condensed light Lb is not exposed or slightly exposed (that is, the degree of exposure is small). In this way, only the positive type photopolymer 32 at the portion irradiated with the condensed light Lb having large luminous intensity (luminous flux) is exposed.

The development is then carried out. In this case, since the photopolymer 32 is a positive type photopolymer, the exposed photopolymer 32 at the portion irradiated with the condensed light Lb having large luminous intensity (luminous flux) is melt and removed by the development. As a result, as shown in FIG. 6E, the black matrix 3 in which the openings 31 are formed on the portions corresponding to the optical axes L of the microlenses 22 is provided. The developing method may be selected arbitrarily depending on composition of the positive type photopolymer 32 or the like. For example, the development of the positive type photopolymer 32 in the present embodiment can be carried out using an alkaline aqueous solution such as a solution of potassium hydroxide or the like.

Now, the irradiation with the light Lb for exposure is carried out while the substrate 6 with concave portions is attached to the main substrate 2. As described above, the absolute index of refraction of the constituent material of the substrate 6 with concave portions is larger than the absolute index of refraction of various gases (for example, air, various inert gases, and the like), and smaller than the absolute index of refraction of the resin material (solidified resin material) constituting the main substrate 2. Therefore, when the light Lb for exposure is made to enter the main substrate 2 while the substrate 6 with concave portions is attached thereto as described above, the degree of refraction of the light Lb for exposure becomes smaller compared with the case where the light Lb for exposure is made to enter the main substrate 2 while the substrate 6 with concave portions is not attached thereto. Thus, in the case where the light Lb for exposure is made to enter the main substrate 2 while the substrate 6 with concave portions is not attached thereto, it is possible to enlarge the degree of the refraction of light compared with the case where the light Lb for exposure is made to enter the main substrate 2 while the substrate 6 with concave portions is attached thereto. For this reason, it seems that it is preferable that the light Lb for exposure is made to enter the main substrate 2 while the substrate 6 with concave portions is attached thereto in view of the selective formation of the openings (light non-shielding portion) 31 and improvement of the contrast of an image. However, the inventor found that there is any following problem in this case. Namely, the light condensed by the microlenses 21 does not have even luminous intensity (luminous flux) at the light irradiated portion, but has predetermined luminous intensity distribution (see FIG. 7B). For this reason, it is impossible to expose the material for forming a light shielding layer at the potion where the luminous intensity (luminous flux) is relatively low (that is, the luminous intensity (luminous flux) is lower than luminous intensity Z₀ required for exposure) although the portion is irradiated with the light. In other words, the size of a spot of light at the light emission surface side of the main substrate 2 (that is, a spot diameter of refracted light) becomes larger than the size of the each of the openings (light non-shielding portion) 31 to be formed. As a result, when the parallel light La is made to enter the microlens substrate 1 finally obtained, the rate of light (refracted light) absorbed in the black matrix 3 becomes high, and therefore, this makes the light use efficiency of the transmission screen 10 provided with the microlens substrate 1 become lower.

Thus, in the invention, the process to expose the material for forming a light shielding layer is carried out while the substrate 6 with concave portions (which is formed of a material having a predetermined absolute index of refraction larger than the absolute index of refraction of various gases (for example, air, various inert gases, and the like) and smaller than the absolute index of refraction of the resin material (solidified resin material) constituting the main substrate 2) is attached to the main substrate 2. Thus, as shown in FIG. 7A, it is possible to irradiate a wider region of the light shielding layer with the light having sufficient luminous intensity (luminous flux) compared with the case where the substrate 6 with concave portions are removed from the main substrate 2. As a result, it is possible to particularly heighten the light use efficiency of the transmission screen 10 provided with the finally obtained microlens substrate 1 (the microlens substrate 1 from which the substrate 6 with concave portions is removed). Further, by carrying out the process to expose the material for forming the light shielding layer while the substrate 6 with concave portions is attached to the main substrate 2, it is possible to reduce variation of the luminous intensity (luminous flux) (that is, the difference between the maximum value and the minimum value) at the region that is irradiated with the refracted light compared with the case of carrying out the exposure process while the substrate 6 with concave portions is removed from the main substrate 2. For this reason, it is possible to use energy of the light Lb for exposure for exposing the material for forming a light shielding layer effectively, and this makes it possible to use the energy of the light effectively. Moreover, since the portion to become the openings (light non-shielding portion) 31 can be irradiated with the light having small variation of the luminous intensity (luminous flux) (that is, small difference between the maximum value and the minimum value), it is possible to prevent the portion from being irradiated with light having more than required luminous intensity (luminous flux) efficiently. This makes it possible to prevent problems such as deterioration of the constituent material of the main substrate 2 from being generated efficiently.

As described above, in the invention, by carrying out the process to expose the material for forming a light shielding layer while the substrate 6 with concave portions is attached to the main substrate 2, and then removing the substrate 6 with concave portions from the main substrate 2, it is possible to substantially equalize the size of the spot of the refracted light at the light emission surface side of the main substrate 2 with the size of each of the openings 31 (the size of the light non-shielding portion). As a result, it is possible to improve the light use efficiency of the microlens substrate 1 particularly while heightening the contrast of an image sufficiently. Further, in the invention, since the substrate 6 with concave portions is removed from the main substrate 2 at the subsequent step, it is possible to enlarge the index of refraction of light in the microlens substrate 2 finally obtained, and as a result, it is possible to improve the angle of view characteristics of the transmission screen 10 provided with the microlens substrate 1. Moreover, as described above, by carrying out the process to expose the material for forming a light shielding layer while the substrate 6 with concave portions is attached to the main substrate 2, for example, it is possible to improve the stability of the shape of the main substrate 2 while forming the black matrix 3 even in the case where the thickness of the main substrate 2 is relatively thin. This makes it possible to form the black matrix 3 provided with the openings 31 each having a desired shape at a desired portion surely. As a result, it is possible to improve the optical characteristics of the microlens substrate 1 finally obtained.

Furthermore, since the black matrix 3 is formed by irradiating the photopolymer 32 with the light Lb for exposure condensed by the plurality of microlenses 21, it is possible to form the black matrix 3 with simpler process compared with the case of using a photolithography technology, for example.

In this regard, heat treatment such as a post-bake process may be carried out after exposing the positive type photopolymer 32 if needed.

Further, in the above explanation in steps <B3> and <B4>, even though it has been described that the light shielding layer (black matrix 3) is formed using the positive type photopolymer as the material for forming a light shielding layer, a material other than the photopolymer may be utilized as the material for forming a light shielding layer. For example, a reversal process material such as a silver salt sensitive material may be utilized as the material for forming a light shielding layer. In the case where the silver salt sensitive material (reversal process material) is used, it is possible to form a light non-shielding portion having light transmission from the first exposed portion and to form a light shielding portion (light shielding region) from the portion other than the first exposed portion using the method in which the light shielding layer is subjected to a process to desalt only the exposed portion once after the exposure process as described above, and the whole of the light shielding layer is then exposed to develop it.

Moreover, a series of processes of the supply of the material for forming a light shielding layer and exposure as described above may be carried out repeatedly. This makes it possible to form the light shielding layer (black matrix) thicker, and it is possible to improve the contrast of an image further.

Furthermore, in the above explanation in steps <B3> and <B4>, even though it has been described that the material for forming a light shielding layer is directly supplied onto the light emission surface of the main substrate 2, the material for forming a light shielding layer is not directly supplied onto the light emission surface of the main substrate 2. For example, a series of processes of supply of a photosensitive material that cannot achieve sufficient light shielding ability and development is carried out after the exposure process, the process using the material for forming a light shielding layer as described above may be carried out to the light emission surface of the main substrate 2. This makes it possible to form the light shielding layer (black matrix 3) thicker, and it is possible to improve the contrast of an image further.

<B5> Next, a light diffusing portion 4 is formed at the surface side of the main substrate 2 on which the black matrix 3 is provided (see FIG. 6F).

It is possible to form the light diffusing portion 4 by, for example, bonding a light diffusing plate formed in a plate shape in advance to the light emission surface of the main substrate 2, or solidifying a material for forming a light diffusing portion 4 that has fluidity after supplying the material for forming a light diffusing portion 4 onto the light emission surface of the main substrate 2.

As the method of supplying the material for forming a light diffusing portion 4 onto the light emission surface of the main substrate 2, for example, various types of coating methods such as a doctor blade method, a spin coat method, a blush coat method, a spray coating, an electrostatic coating, an electrodeposition coating, a roll coater, and a dipping method in which the main substrate 2 is immersed (soaked) in the material for forming a light diffusing portion 4, and the like may be mentioned.

<B6> Next, the main substrate 2 is released from the substrate 6 with concave portions in the following manner.

First, the portion of the main substrate 2 that is close contact with the mold releasing non-processed portion 63 of the substrate 6 with concave portions (that corresponds to the usable area of the main substrate 2) is removed by cutting it off (see FIG. 6G), and the main substrate 2 is released from the substrate 6 with concave portions (see FIG. 6H). In this way, in the present embodiment, by cutting off the portion of the main substrate 2 that is close contact with the mold releasing non-processed portion 63 of the substrate 6 with concave portions once to remove it, the portion that is close contact with the substrate 6 with concave portions is only the mold releasing processed portion 62 that has been subjected to the mold releasing process. Thus, it is possible to remove the substrate 6 with concave portions from the main substrate 2 easily, and it is possible to prevent defects such as crack from being generated in the formed microlenses 21 more efficiently.

Further, by removing the substrate 6 with concave potions from the main substrate 2, it is possible to refract the incident light La effectively, and this makes it possible to improve the angle of view characteristics of the transmission screen 10 provided with the microlens substrate 1 particularly. Moreover, it is possible to use the removed substrate 6 with concave portions repeatedly when manufacturing the main substrate 2 (that is, microlens substrate 1), and this becomes advantage to reduce the manufacturing costs for the main substrate 2, and to heighten the stability of quality of the main substrate 2 (microlens substrate 1) to be manufactured. Moreover, by removing pieces thus cut off of the main substrate 2 from the substrate 6 with concave portions after removing the substrate 6 with concave portions from the main substrate 2 (for example, by releasing or molting the adhering element 64 by means of an organic solvent or the like if needed), it is possible to repeatedly use the substrate 6 with concave portions as a mold so that the shape and size thereof are not changed substantially. As a result, it is possible to increase the usage count of the substrate 6 with concave portions further, and this becomes further advantage to reduce the manufacturing costs for the main substrate 2 (that is, microlens substrate 1) and to heighten the stability of quality of the main substrate 2 (that is, microlens substrate 1) to be manufactured.

In this regard, in the above explanation, even though it has been described that the portion of the main substrate 2 that is close contact with the mold releasing non-processed portion 63 of the substrate 6 with concave portions is removed from the main substrate 2 by cutting it off, the mold releasing non-processed portion 63 may be removed from the substrate 6 with concave portions by cutting it off, or a predetermined portion of the main substrate 2 and a corresponding portion of the substrate 6 with concave portions may be removed by cutting them off. Even in these cases, it is possible to obtain the effects as described above.

<B7> Then, by supplying a coloring liquid onto the main substrate 2 that has been released from the substrate 6 with concave portions, a colored portion 22 is formed, whereby a microlens substrate 1 is obtained (see FIG. 6I).

The coloring liquid is not particularly limited, and in the present embodiment, the coloring liquid is one containing a coloring agent and benzyl alcohol. The invention found that it is possible to carry out the coloring of the main substrate easily and surely by using such a coloring liquid. In particular, according to the processes, it is possible to subject a main substrate 2 formed of a material such as an acrylic based resin which it is difficult to color in a conventional coloring method to a coloring process easily and surely. It is thought that this is for the following reasons.

Namely, by using the coloring liquid containing benzyl alcohol, the benzyl alcohol in the coloring liquid penetrates the main substrate 2 deeply and diffuses therein, whereby the bonding of molecules (the bonding between the molecules) constituting the main substrate 2 is loosened, and spaces in which the coloring agent is to penetrate are secured. The benzyl alcohol and the coloring agent in the coloring liquid are replaced, by which the coloring agent is held in the spaces (which can be likened to seats for the coloring agent (coloring seats)), and therefore, the surface of the main substrate 2 is colored.

Further, by using the coloring liquid as described above, it is possible to form the colored portion 22 having an even thickness easily and surely. In particular, even though a main substrate (that is, work) to be colored is one in which a minute structure such as microlenses is provided on the surface thereof (one in which a cycle of unevenness in a two-dimensional direction of the surface thereof is small) or one in which the region to be colored is a large area, it is possible to form the colored portion 22 with an even thickness (that is, without color heterogeneity).

As the method of supplying the coloring liquid onto the light incident surface of the main substrate 2, for example, various types of coating methods such as a doctor blade method, a spin coat method, a blush coat method, a spray coating, an electrostatic coating, an electrodeposition coating, printing, a roll coater, and a dipping method in which the main substrate 2 is immersed (soaked) in the coloring liquid, and the like may be mentioned. The dipping method (in particular, dip dyeing) is suitable among these methods. This makes it possible to form the colored portion 22 (in particular, the colored portion 22 having an even thickness) easily and surely. Further, in particular, in the case where the coloring liquid is supplied onto the main substrate 2 by means of dip dyeing, it is possible to color even a main substrate 2 formed of a material such as an acrylic based resin which it is difficult to color in a conventional coloring method easily and surely. It is thought that this is because the dye that can be used for dip dyeing has high affinity to an ester group (ester bonding) that acrylic based resin or the like has.

It is preferable that the coloring liquid supplying step is carried out while the coloring liquid and/or the main substrate 2 are heated at the range of 60 to 100° C. This makes it possible to form the colored portion 22 efficiently while preventing a harmful influence (for example, deterioration of the constituent material of the main substrate 2) on the main substrate 2 on which the colored portion 22 is to be formed from being generated sufficiently.

Further, the coloring liquid supplying step may be carried out while the ambient pressure is heightened (with application of pressure). This makes it possible to accelerate the penetration of the coloring liquid into the inside of the main substrate 2, and as a result, it is possible to form the colored portion 22 efficiently with a short time.

In this regard, the step of supplying the coloring liquid may be carried out repeatedly (that is, multiple times) if needed (for example, in the case where the thickness of the colored portion 22 to be formed is relatively large). Further, the main substrate 2 may be subjected to heat treatment such as heating, cooling and the like, irradiation with light, pressurization or decompression of the atmosphere, or the like after supplying the coloring liquid if needed. This makes it possible to accelerate the fixing (stability) of the colored portion 22.

Hereinafter, the coloring liquid used at the present step will be described in detail.

The content by percentage of the benzyl alcohol in the coloring liquid is not particularly limited. It is preferable that the content by percentage of the benzyl alcohol is in the range of 0.01 to 10.0% by weight. More preferably it is in the range of 0.05 to 8.0% by weight, and further more preferably it is in the range of 0.1 to 5.0% by weight. In the case where the content by percentage of benzyl alcohol is restricted within the above ranges, it is possible to form the suitable colored portion 22 easily and surely while preventing a harmful influence (such as deterioration of the constituent material of the main substrate 2) on the main substrate 2 on which the colored portion 22 is to be formed from being generated more efficiently.

The coloring agent contained in the coloring liquid may be any one such as various dyes and various pigments, but it is preferable that the coloring agent is a dye. More preferably it is a disperse dye and/or a cationic dye, and further more preferably it is a disperse dye. This makes it possible to form the colored portion 22 efficiently while preventing a harmful influence on the main substrate 2 on which the colored portion 22 is to be formed (for example, deterioration of the constituent material of the main substrate 2) from being generated sufficiently. In particular, it is possible to color even a main substrate 2 formed of a material such as an acrylic based resin which it is difficult to color in a conventional coloring method easily and surely. It is thought that this is because it is easy to color such a material because the coloring agent as described above uses ester functions (ester bonding) that acrylic based resin or the like has as the coloring seats.

As described above, although the coloring liquid used in the present embodiment contains at least the coloring agent and benzyl alcohol, it is preferable that the coloring liquid further contains at least one compound selected from the benzophenone based compound and the benzotriazole based compound and benzyl alcohol. This makes it possible to form the colored portion 22 more efficiently while preventing a harmful influence (for example, deterioration of the constituent material of the main substrate 2) on the main substrate 2 on which the colored portion 22 is to be formed from being generated sufficiently. It is thought that this is for the following reasons.

Namely, by using the coloring liquid containing benzyl alcohol, and at least one kind of compound selected from a benzophenone based compound and a benzotriazole based compound (hereinafter, benzyl alcohol, the benzophenone based compound and the benzotriazole based compound are collectively referred to as “additives”), the additives in the coloring liquid penetrates the main substrate 2 and diffuses therein, whereby the bonding of molecules (the bonding between the molecules) constituting the main substrate 2 is loosened, and spaces in which the coloring agent is to penetrate are secured. The additives and the coloring agent are replaced, by which the coloring agent is held in the spaces (which can be likened to seats for the coloring agent (coloring seats)), and therefore, the surface of the main substrate 2 is colored. It is thought that this is because, by using the at least one compound selected from the benzophenone based compound and the benzotriazole based compound and benzyl alcohol together, they interact with each other in a complementary manner, and the coloring by the coloring liquid becomes good.

As for the benzophenone based compound, a compound having a benzophenone skeleton, its tautomers, or these inductors (for example, addition reaction products, substitution reaction products, reductive reaction products, oxidation reaction products and the like) can be utilized.

As for such compounds, for example, benzophenone, 2,4-dihydroxybenzophenone, 2-hydroxy-4-methoxybenzophenone, 2,2′-dihydroxy-4,4′-dimethoxybenzophenone, 2,2′,4,4′-tetrahydroxybenzophenone, 2-hydroxy-4-octylbenzophenone, 4-benzyloxy-2-hydroxybenzophenone, benzophenone anil, benzophenone oxime, benzophenone chloride (α,α′-dichlorodiphenylmethane) and the like may be mentioned. The compound that has benzophenone skeleton is preferable among these compounds, and more preferably the compound is any one of 2,2′-dihydroxy-4,4′-dimethoxybenzophenone and 2,2′,4,4′-tetrahydroxybenzophenone. By using such a benzophenone based compound, the effects as described above appear remarkably.

Further, as for the benzotriazole based compound, a compound having a benzotriazole skeleton, its tautomers, or these inductors (for example, addition reaction products, substitution reaction products, reductive reaction products, oxidation reaction products and the like) can be utilized.

As for such compounds, for example, benzotriazole, 2-(2-hydroxy-5-methylphenyl)-2H-benzotriazole, 2-(2-hydroxy-4-octyloxyphenyl)-2H-benzotriazole and the like may be mentioned. The compound that has benzotriazole skeleton is preferable among these compounds, and more preferably the compound is any one of 2-(2-dihydroxy-5-methylphenyl)-2H-benzotriazole and 2-(2-hydroxy-4-octyloxyphenyl)-2H-benzotriazole. By using such a benzotriazole based compound, the effects as described above appear remarkably.

In the case where the benzophenone based compound and/or the benzotriazole based compound is contained in the coloring liquid, the total content by percentage of the benzophenone based compound and the benzotriazole based compound in the coloring liquid is not particularly limited. It is preferable that the total content by percentage of the benzophenone based compound and the benzotriazole based compound in the coloring liquid is in the range of 0.001 to 10.0% by weight. More preferably it is in the range of 0.005 to 5.0% by weight, and further more preferably it is in the range of 0.01 to 3.0% by weight. In the case where the total content by percentage of the benzophenone based compound and the benzotriazole based compound is restricted within the above ranges, it is possible to form the suitable colored portion 22 easily and surely while preventing a harmful influence (such as deterioration of the constituent material of the main substrate 2) on the main substrate 2 on which the colored portion 22 is to be formed from being generated more efficiently.

Further, in the case where the benzophenone based compound and/or the benzotriazole based compound is contained in the coloring liquid, and the content by percentage of the benzophenone-based compound in the coloring liquid is defined as X (% by weight) and the total content by percentage of the benzophenone based compound and the benzotriazole based compound in the coloring liquid is defined as Y (% by weight), then it is preferable that X and Y satisfy the relation: 0.001≦X/Y≦10000. More preferably X and Y satisfy the relation: 0.05≦X/Y≦1000, and further more preferably X and Y satisfy the relation: 0.25≦X/Y≦500. In the case where X and Y satisfy the relations as described above, synergistic effects by using the benzophenone based compound and/or the benzotriazole based compound together with benzyl alcohol are exerted more remarkably. In addition, it is possible to form the suitable colored portion 22 with a high speed easily and surely while preventing a harmful influence (such as deterioration of the constituent material of the main substrate 2) on the main substrate 2 on which the colored portion 22 is to be formed from being generated more efficiently.

Further, it is preferable that the coloring liquid further contains benzyl alcohol and a surfactant. This makes it possible to disperse the coloring agent stably and evenly even under the conditions in which benzyl alcohol exists. Even though the main substrate 2 onto which the coloring liquid is to be supplied is formed of a material such as an acrylic based resin that it is difficult to color in a conventional method, it is possible to color the main substrate 2 easily and surely. As for a surfactant, nonionic surfactants, anionic surfactants, cationic surfactants, ampholytic surfactants and the like may be mentioned. As for the nonionic surfactant, for example, ether based surfactants, ester based surfactants, ether ester based surfactants, nitrogenous based surfactants and the like may be mentioned. More specifically, polyvinyl alcohol, carboxymethylcellulose, polyethylene glycol, acrylic ester, methacrylic ester, and the like may be mentioned. Further, as for anionic surfactants, for example, various kinds of rosins, various kinds of carboxylates, various kinds of ester sulfates, various kinds of sulfonates, various kinds of ester phosphates, and the like may be mentioned. More specifically, gum rosin, polymerized rosin, disproportionated rosin, maleic rosin, fumaric rosin, maleic rosin pentaester, maleic rosin glycerolester, tristearate (for example, metal salt such as aluminum salt), distearate (for example, metal salt such as aluminum salt, barium salt), stearate (for example, metal salt such as calcium salt, lead salt, zinc lead salt), linolenate (for example, metal salt such as cobalt salt, manganese salt, lead salt, zinc salt), octanoate (for example, metal salt such as aluminum salt, calcium salt, cobalt salt), oleate (for example, metal salt such as calcium salt, cobalt salt), palmitate (metal salt such as zinc salt), naphthenate (for example, metal salt such as calcium salt, cobalt salt, manganese salt, lead salt, zinc salt), resinate (for example, metal salt such as calcium salt, cobalt salt, manganese salt, zinc salt), polyacrylate (for example, metal salt such as sodium salt), polymethacrylate (for example, metal salt such as sodium salt), polymaleate (for example, metal salt such as sodium salt), acrylate-maleate copolymer (for example, metal salt such as sodium salt), cellulose, dodecylbezenesulfonate (for example, metal salt such as sodium salt), alkylsulfonate salt, polystyrenesulfonate, (for example, (for example, metal salt such as sodium salt), alkyldiphenyletherdisulfonate (for example, metal salt such as sodium salt), and the like may be mentioned. Further, as for cationic surfactants, for example, various kinds of ammonium salts such as primary ammonium salt, secondary ammonium salt, tertiary ammonium salt, quaternary ammonium salt may be mentioned. More specifically, monoalkylamine salt, dialkylamine salt, trialkylamine salt, tetraalkylamine salt, benzalkonium salt, alkylpyridinium salt, imidazolium salt, and the like may be mentioned. Further, as for ampholytic surfactants, for example, various kinds of betaines such as carboxybetaine, sulfobetaine, various kinds of aminocarboxylic acids, various kinds of ester phosphate salts, and the like may be mentioned.

Hereinafter, a description will be given for a rear projection using the transmission screen described above.

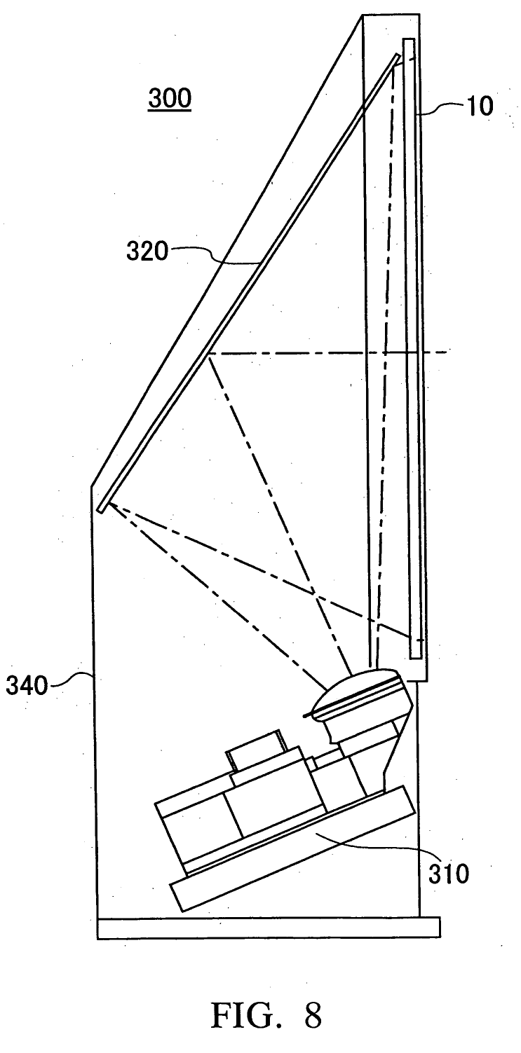

FIG. 8 is a cross-sectional view which schematically shows a rear projection 300 to which the transmission screen 10 of the present invention is applied. As shown in FIG. 8, the rear projection 300 has a structure in which a projection optical unit 310, a light guiding mirror 320 and a transmission screen 10 are arranged in a casing 340.

Since the rear projection 300 uses the transmission screen 10 that has excellent angle of view characteristics and light use efficiency as described above, it is possible to obtain image having excellent contrast. In addition, since the rear projection 300 has the structure as described above in the present embodiment, it is possible to obtain excellent angle of view characteristics and light use efficiency, in particular.

Further, since the microlenses 21 each having a substantially ellipse shape are arranged in a houndstooth check manner on the microlens substrate 1 described above, the rear projection 300 hardly generates problems such as moire, in particular.

As described above, it should be noted that, even though the method of manufacturing a microlens substrate 1, the microlens substrate 1, the transmission screen 10 and the rear projection 300 according to the present invention have been described with reference to the preferred embodiments shown in the accompanying drawings, the present invention is not limited to these embodiments. For example, each element (component) constituting the microlens substrate 1, the transmission screen 10 and the rear projection 300 may be replaced with one capable of performing the same or a similar function.

Further, in the embodiment described above, even though it has been described that the spacers 20 each having an index of refraction nearly equal to that of the resin material 23 (that is, the resin material 23 after solidification) are used as spacers, each of the spacers 20 having an index of refraction nearly equal to that of the resin material 23 (that is, the resin material 23 after solidification) is not required in the case where the spacers 20 are arranged only in the region where no concave portions 61 of the substrate 6 with concave portions are formed (unusable lens area). Moreover, the spacers 20 as described above do not always have to be utilized in manufacturing the microlens substrate 1.

Moreover, in the embodiment described above, even though it has been described that the resin material 23 is supplied onto the surface of the substrate 6 with concave portions, the microlens substrate 1 may be manufactured so that, for example, the resin material 23 is supplied onto the surface of the flat plate 9 and the resin material 23 is then pressed by the substrate 6 with concave portions.

Furthermore, in the embodiment described above, even though it has been described that at the initial hole formation step in the method of manufacturing the substrate 6 with concave portions the initial concave portions 71 was formed in the substrate 7 in addition to the initial holes 81, there is no need to form such initial concave portions 71. By appropriately adjusting the formation conditions for the initial holes 81 (for example, energy intensity of a laser, the beam diameter of the laser, irradiation time or the like), it is possible to form the initial concave portions 71 each having a predetermined shape, or it is possible to selectively form only the initial holes 81 so that the initial concave portions 71 are not formed.

Further, in the embodiment described above, even though it has been described that the mold releasing non-processed portion 63 that is not subjected to the mold releasing process is formed on almost the whole of the unusable area of the substrate 6 with concave portions, for example, the mold releasing non-processed portion 63 may be provided on a part of the unusable area. Even in this case, it is possible to obtain the effects as described above. Moreover, by providing the mold releasing non-processed portion 63 on a part of the unusable area in this way, it is possible to remove the substrate 6 with concave portions from the main substrate 2 more easily, and this becomes advantage to reuse the substrate 6 with concave portions.

Furthermore, in the embodiment described above, even though it has been described that the microlens substrate 1 is provided with the layer-shaped light diffusing portion 4, the shape of the light diffusing portion 4 is not limited thereto. For example, the light diffusing portions 4 may be provided in a convex manner at the portions corresponding to the positions of the openings 31 of the black matrix 3. Even in this case, it is possible to obtain the effects as described above. Further, by forming such light diffusing portions 4 at the portions corresponding to the positions of the openings 31 of the black matrix 3, since it is possible to prevent outside light from being reflected at the portion other than the openings 31 of the black matrix 3 more efficiently, it is possible to improve the contrast of an obtained image particularly. Moreover, the microlens substrate 1 need not be provided with the light diffusing portion 4 as described above.

Further, in the embodiment described above, even though it has been described that the transmission screen 10 is provided with the microlens substrate 1 and the Fresnel lens 5, the transmission screen 10 of the present invention need not be provided with the Fresnel lens 5 necessarily. For example, the transmission screen 10 may be constructed from only the microlens substrate 1 of the present invention practically, or may be constructed from only the substrate 6 with concave portions.

Furthermore, in the embodiments described above, even though it has been described that the microlens substrate 1 is a member constituting the transmission screen 10 or the rear projection 300, the microlens substrate 1 is not limited to one to be applied described above, and it may be applied to one for any use. For example, the microlens substrate 1 of the invention may be applied to a light diffusing plate, a black matrix screen, a screen (screen of a front projection) of a projection display (front projection), a constituent member of a liquid crystal light valve in a projection display (front projection) and the like.

### EXAMPLE

<Manufacture of Microlens Substrate and Transmission Screen>

### Example 1

A substrate with concave portions that was provided with a plurality of concave portions for forming microlenses was manufactured in the following manner.

First, a soda-lime glass substrate (an absolute index of refraction of the soda-lime glass substrate n₂: 1.50) having a rectangle shape of 1.2 m (lateral)×0.7 m (longitudinal) and a thickness of 4.8 mm was prepared.

The soda-lime glass substrate was soaked in cleaning liquid containing 4% by weight ammonium hydrogen difluoride and 8% by weight hydrogen peroxide to carry out a 6 μm etching process, thereby cleaning its surface. Then, cleaning with pure water and drying with nitrogen (N₂) gas (for removal of pure water) were carried out.

Next, a laminated structure of chromium/chromium oxide (that is, laminated structure in which a layer formed of chromium oxide was laminated on the outer circumference of a layer formed of chromium) was formed on one major surface of the soda-lime glass substrate by means of a spattering method. Namely, a mask and a back surface protective film each made of the laminated structure constructed from the layer formed of chromium and the layer formed of chromium oxide were formed on both surfaces of the soda-lime glass substrate. In this case, the thickness of the chromium layer is 0.03 μm, while the thickness of the chromium oxide layer is 0.01 μm.

Next, laser machining was carried out to the mask to form a large number of initial holes within a region of 113 cm×65 cm at the central part of the mask. In this regard, the laser machining was carried out using a YAG laser under the conditions of energy intensity of 1 mW, a beam diameter of 3 μm, and an irradiation time of 60×10⁻⁹ seconds The beam diameter (spot diameter) a scanning speed of 0.1 m/second.

In this way, the initial holes each having a predetermined length were formed in a houndstooth check pattern over the substantially entire region of the mask mentioned above. The average width of each of the initial holes was 2 μm, and the average length thereof is 2 μm. Further, at this time, concave portions each having a depth of about 50 Å and a damaged layer (or affected layer) were formed on the surface of the soda-lime glass substrate.

Next, the soda-lime glass substrate was subjected to a wet etching process, thereby forming a large number of concave portions (concave portions for forming microlenses) on the major surface of the soda-lime glass substrate. The shape of each of the concave portions is a substantially elliptic shape (flat shape) when viewed from above the major surface of the soda-lime glass substrate. The large number of concave portions thus formed had substantially the same shape as each other. The length of each of the formed concave portions in the short axis direction (diameter), the length of each of the formed concave portions in the long axis direction, the radius of curvature and depth of each of the formed concave portions were 54 μm, 72 μm, 38 μm and 37 μm, respectively. Further, the share of the concave portions in a usable area in which the concave portions were formed was 100%.

In this regard, an aqueous solution containing 4% by weight ammonium hydrogen difluoride and 8% by weight hydrogen peroxide was used for the wet etching process as an etchant, and the soak time of the substrate was 125 minutes.

Next, the mask and the back surface protective film were removed by carrying out an etching process using a mixture of ceric ammonium nitrate and perchloric acid.

Next, cleaning with pure water and drying with N₂ gas (removal of pure water) were carried out.

Then, an adhering element to which a separating sheet was attached was applied to the region where the concave portions have not been formed.

Then, the surface side of the base substrate on which the concave portions have been formed (to which the adhering element has been applied) was subjected to gas phase surface treatment (silylate treatment) by hexamethyldisilazane to form a mold releasing processed portion.

In this way, the substrate with concave portions (the substrate with concave portions to which the separating sheet has been applied) corresponding to the microlens substrate as shown in FIG. 2 in which the large number of concave portions for forming microlenses were arranged in a houndstooth check manner on the major surface of the soda-lime glass substrate was obtained. In this regard, the thickness of the adhering element was 500 μm. Further, a ratio of an area occupied by all the concave portions in the obtained substrate with concave portions in a usable area where the concave portions were formed with respect to the entire usable area was 97% when viewed from above the major surface of the soda-lime glass substrate.

Next, the separating sheet was removed from the adhering element corresponding to the substrate with concave portions, and a non-polymerized (uncured) acrylic based resin (PMMA resin (methacryl resin)) was applied to the surface side of the substrate with concave portions on which the concave portions have been formed. At this time, substantially spherical-shaped spacers (each having a diameter of 50 μm) formed of hardened material of the acrylic based resin (PMMA resin (methacryl resin)) were arranged over the substantially entire surface of the substrate with concave portions for forming microlenses. Further, the spacers are arranged at the rate of 3 pieces/cm².

Next, the acrylic based resin was pressed (pushed) with the major surface of a flat plate formed of soda-lime glass. At this time, this process was carried out so that air was not intruded between the substrate with concave portions and the acrylic based resin. Further, such a flat plate the surface of which was subjected to the gas phase surface treatment (mold releasing process) by hexamethyldisilazane was utilized as the flat plate.

Then, by heating the substrate with concave portions at 120° C., the acrylic based resin was cured to obtain a main substrate. The index of refraction n₁ of the obtained main substrate (that is, cured acrylic based resin) was 1.51. The thickness of the obtained main substrate (except for portion where the microlenses were formed) was 50 μm. The length of each of the formed microlenses in the short axis direction thereof (diameter), the length of each of the formed microlenses in the long axis direction thereof, the radius of curvature and depth of each of the formed microlenses were 54 μm, 72 μm, 37.5 μm and 36.5 μm, respectively. Further, the share of the microlenses in a usable area in which the concave portions were formed was 100%.

Next, the flat plate was removed from the main substrate.

Next, a positive type photopolymer to which a light shielding material (carbon black) was added (PC405G: made by JSR Corporation) was supplied onto the light emission surface of the main substrate (the surface opposite to the surface thereof on which the microlenses had been formed) by means of a roll coater. The content by percentage of the light shielding material in the photopolymer was 20% by weight.

Next, the main substrate was subjected to a pre-bake process of 90°×30 minutes.

Next, ultraviolet rays of 60 mJ/cm² were irradiated through the surface opposite to the surface of the substrate with concave portions on which the concave portions have been formed as parallel light. As a result, the irradiated ultraviolet rays were condensed by each of the microlenses, and the photopolymer at the portion irradiated with the condensed ultraviolet rays was exposed selectively.

The main substrate was then subjected to a developing process for 40 seconds using an aqueous solution containing 0.5% by weight KOH.

Then, cleaning with pure water and drying with N₂ gas (removal of pure water) were carried out. Further, the main substrate was subjected to a post-bake process of 200° C.×30 minutes. Thus, a black matrix having a plurality of openings respectively corresponding to the microlenses was formed. Each of the openings had a substantially elliptic shape, and the length (diameter) of each of the openings in the short axis direction thereof was 30 μm, and the length of each of the openings in the long axis direction thereof was 35 μm. Further, the thickness of the formed black matrix was 5.0 μm.

Next, a light diffusing portion was formed on the surface side of the main substrate on which the black matrix has been formed. The formation of the light diffusing portion was carried out by bonding a diffused plate having a structure in which diffusion media (silica particles having average grain diameter of 8 μm) were diffused in the acrylic resin to the main substrate by means of heat sealing. In this regard, the thickness of the light diffusing portion was 2.0 mm.

Next, the portion that is close contact with the mold releasing non-processed portion of the substrate with concave portions was removed from the main substrate by cutting it off, and the substrate with concave portions was removed from the main substrate.

A coloring liquid was then supplied to the main substrate by means of dip dyeing. This process was carried out so that the whole surface on which the microlenses were formed was brought into contact with the coloring liquid, but the surface on which the black matrix has been formed was not in contact with the coloring liquid. Further, the temperature of the main substrate and the coloring liquid when supplying the coloring liquid onto the main substrate was adjusted to be 90° C. Moreover, the pressure of the atmosphere was pressurized at the coloring liquid supplying process so as to be 120 kPa. A mixture containing disperse dye (Blue) (made by Futaba Sangyo): 2 part by weight, disperse dye (Red) (made by Futaba Sangyo): 0.1 part by weight, disperse dye (Yellow) (made by Futaba Sangyo): 0.05 part by weight, benzyl alcohol: 10 part by weight, a surfactant: 2 part by weight, and pure water: 1000 part by weight was used as the coloring liquid.

After the main substrate was brought into contact with the coloring liquid for 20 minutes under the conditions as described above, the main substrate was brought out from a bath in which the coloring liquid was stored, and the main substrate was then washed and dried.

By carrying out cleaning the main substrate with pure water and drying it with N₂ gas (removal of pure water), a microlens substrate on which the colored portion has been formed was obtained. The color density of the colored portion thus formed was 70%.

By assembling the microlens substrate manufactured as described above and a Fresnel lens manufactured by extrusion molding, the transmission screen as shown in FIG. 3 was obtained.

### Examples 2 to 8

A microlens substrate and a transmission screen were manufactured in the manner similar to those in Example 1 described above except that the shape of each of the concave portions and the arrangement pattern of the concave portions of the substrate with concave portions were changed by changing any of the structure of the mask, the conditions of the irradiation with laser beams (that is, the shape of each of the initial holes to be formed and the depth of each of the initial concave portions), the soaking time into the etchant and the resin material for forming the main substrate, whereby the shape of each of the microlenses to be formed on the microlens substrate, the arrangement pattern of the microlenses, the index of refraction of the main substrate and the like were changed as shown in TABLE 1.

### Comparative Example 1

A microlens substrate and a transmission screen were manufactured in the manner similar to those in Example 8 described above except that the supply of the positive type photopolymer for forming the black matrix and the exposure thereof were carried out after removing the substrate with concave portions from the main substrate.

### Comparative Example 2

A microlens substrate and a transmission screen were manufactured in the manner similar to those in Example 8 described above except that the black matrix has not been formed on the major surface of the main substrate.

### Comparative Example 3

A microlens substrate and a transmission screen were manufactured in the manner similar to those in Example 1 described above except that one formed of a glass material having the absolute index of refraction of 1.90 was used as the substrate with concave portions.

A configuration of the mask, the shape of each of the initial holes formed by means of the irradiation with laser beams and the depth of each of the initial concave portions when manufacturing the substrate with concave portions, the shape of each of the concave portions and the arrangement pattern of the concave portions in the substrate with concave portions, the index of refraction of the constituent material of the substrate with concave portions, the shape of each of the manufactured microlenses, the arrangement pattern of the manufactured microlenses, and the index of refraction of the constituent material of the main substrate and the like in each of Examples 1 to 8 and Comparative Examples 1 to 3 were shown in TABLE 1 as a whole.

TABLE 1

| | Mask | Initial Hole | | | Initial | Microlers | | | | | | |
|---|---|---|---|---|---|---|---|---|---|---|---|---|
| | Surface | | Length | Length | Concave | | Length L₁ | Length L₁ | | | | |
| | Side/ | | (Short | (Long | Portion | | (Short | (Long | | | | |
| | Substrate | | Axis) | Axis) | Depth | Arrangement | Axis) | Axis) | Height H | | | |
| | Side | Shape | (μm) | (μm) | (Å) | Pattern | (μm) | (μm) | (μm) | L₁/H | L₁/L₂ | Shape |
| EX. 1 | Cr/CrO | SC | 2 | 2 | 50 | HC | 54 | 72 | 36.5 | 1.48 | 0.75 | SE |
| EX. 2 | Cr/CrO | SC | 2 | 2.1 | 50 | SL | 20 | 22 | 28 | 0.71 | 0.91 | SE |
| EX. 3 | Cr/CrO | SC | 2 | 2 | 50 | SL | 40 | 44 | 56 | 0.71 | 0.91 | SE |
| EX. 4 | Cr/CrO | SC | 2 | 2.2 | 50 | SL | 60 | 66 | 84 | 0.71 | 0.91 | SE |
| EX. 5 | Cr/CrO | SC | 2 | 2.1 | 50 | HC | 27 | 36 | 18.5 | 1.46 | 0.75 | SE |
| EX. 6 | Au/Cr | SC | 2 | 2 | 50 | HC | 38 | 50 | 68 | 0.56 | 0.76 | SE |
| EX. 7 | Cr/CrO | SC | 2 | 2.3 | 50 | HC | 54 | 72 | 36.5 | 1.48 | 0.75 | SE |
| EX. 8 | Au/Cr | SC | 2 | 2 | 50 | RD | 40 | 40 | 56 | 0.71 | 1 | SC |
| Co. EX. 1 | Au/Cr | SC | 2 | 2 | 50 | RD | 40 | 40 | 56 | 0.71 | 1 | SC |
| Co. EX. 2 | Au/Cr | SC | 2 | 2 | 50 | RD | 40 | 40 | 56 | 0.71 | 1 | SC |
| Co. EX. 3 | Au/Cr | SC | 2 | 2 | 50 | HC | 38 | 50 | 68 | 0.56 | 0.76 | SE |

| | Black Matrix | | | | | | | | |
|---|---|---|---|---|---|---|---|---|---|
| | | Opening | | | | | | | |
| | | Length L₁′ | Length L₁′ | | | | | | |
| | | (Short | (Short | | | | Index of | Index of | |
| | Thickness | Axis) | Axis) | | | | Refraction | Refraction | |
| | (μm) | (μm) | (μm) | L₁′/L₂′ | L₁′/L₁ | L₁′/L₂ | n [symbol] | n [symbol] | n₁-n₂ |
| EX. 1 | 5 | 30 | 35 | 0.86 | 0.56 | 0.49 | 1.51 | 1.5 | 0.01 |
| EX. 2 | 5 | 10 | 11 | 0.91 | 0.5 | 0.5 | 1.68 | 1.5 | 0.18 |
| EX. 3 | 4 | 20 | 22 | 0.91 | 0.5 | 0.5 | 1.505 | 1.5 | 0.005 |
| EX. 4 | 5 | 30 | 33 | 0.91 | 0.5 | 0.5 | 1.61 | 1.5 | 0.11 |
| EX. 5 | 5 | 14 | 17 | 0.82 | 0.52 | 0.47 | 1.88 | 1.5 | 0.38 |
| EX. 6 | 6 | 18 | 19 | 0.95 | 0.47 | 0.38 | 1.76 | 1.5 | 0.26 |
| EX. 7 | 4 | 23 | 25 | 0.92 | 0.43 | 0.35 | 2 | 1.5 | 0.5 |
| EX. 8 | 4 | 20 | 20 | 1 | 0.5 | 0.5 | 1.88 | 1.5 | 0.38 |
| Co. EX. 1 | 4 | 10 | 10 | 1 | 0.25 | 0.25 | 1.8 | — | — |
| Co. EX. 2 | — | — | — | — | — | — | 1.8 | — | — |
| Co. EX. 3 | 5 | 20 | 24 | 0.83 | 0.53 | 0.48 | 1.8 | 1.9 | −0.1 |

SHAPE SC: Substantially Circular SE: Substantially Elliptic
ARRANGEMTNT PATTERN HC: Houndstooth Check SL: Square Lattice RD: Random

<Evaluation of Light Use Efficiency>

The evaluation for light use efficiency was carried out with respect to the transmission screen of each of Examples 1 to 8 and Comparative Examples 1 to 3 described above.

The evaluation for the light use efficiency was carried out by calculating the ratio (B/A) of luminance B (cd/m²) of light measured at the light emission surface side of the transmission screen when white light of A (=300) (cd/m²) entered the transmission screen. It would be said that the larger the value of B/A is, the more excellent the light use efficiency is.

<Manufacture of Rear Projection>

A rear projection as shown in FIG. 8 was manufactured (assembled) using the transmission screen manufactured in each of Examples 1 to 8 and Comparative Examples 1 to 3.

<Evaluation for Contrast>

The evaluation for contrast was carried out with respect to the rear projection of each of Examples 1 to 8 and Comparative Examples 1 to 3 described above.

A ratio LW/LB of front side luminance (white luminance) LW (cd/m²) of white indication when total white light having illuminance of 413 luces entered the transmission screen in the rear projection at a dark room to the increasing amount of front side luminance (black luminance increasing amount) LB (cd/m²) of black indication when a light source was fully turned off at a bright room was calculated as contrast (CNT). In this regard, the black luminance increasing amount is referred to as the increasing amount with respect to luminance of black indication at a dark room. Further, the measurement at the bright room was carried out under the conditions in which the illuminance of outside light was about 185 luces, while the measurement at the dark room was carried out under the conditions in which the illuminance of outside light was about 0.1 luces.

<Measurement of Angle of View>

The measurement of angles of view in both horizontal and vertical directions was carried out while a sample image was displayed on the transmission screen in the rear projection of each of Examples 1 to 8 and Comparative Examples 1 to 3. The measurement of the angles of view was carried out under the conditions in which the measurement was carried out at intervals of one degree with a gonio photometer.

<Evaluation of Diffracted Light, Moire and Color Heterogeneity>

A sample image was displayed on the transmission screen of the rear projection in each of Examples 1 to 8 and Comparative Examples 1 and 2 described above. The generation status of diffracted light, moire and color heterogeneity in the displayed sample image was evaluated on the basis of the following four-step standard.

A: No diffracted light, moire and color heterogeneity was recognized.

B: Little diffracted light, moire and color heterogeneity was recognized.

C: At least one of diffracted light, moire and color heterogeneity was slightly recognized.

D: At least one of diffracted light, moire and color heterogeneity was remarkably recognized.

These results of the measurement of angles of view were shown in TABLE 2 as a whole.

TABLE 2

| | | | Angle of View (°) | | |
|---|---|---|---|---|---|
| | Light Use | Bright | Half Value | | Color |
| | Efficiency | Room | Vertical | Horizontal | Heterogeneity |
| | B/A | Cotrast | Direction | Direction | and the like |
| EX. 1 | 0.85 | 720 | 22 | 23 | A |
| EX. 2 | 0.82 | 650 | 23 | 24 | A |
| EX. 3 | 0.85 | 640 | 22 | 23 | A |
| EX. 4 | 0.83 | 660 | 21 | 22 | A |
| EX. 5 | 0.75 | 670 | 22 | 23 | A |
| EX. 6 | 0.76 | 700 | 23 | 24 | A |
| EX. 7 | 0.74 | 710 | 22 | 23 | A |
| EX. 8 | 0.75 | 730 | 21 | 23 | B |
| Co. EX. 1 | 0.5 | 510 | 20 | 22 | D |
| Co. EX. 2 | 0.55 | 470 | 22 | 24 | D |
| Co. EX. 3 | 0.53 | 520 | 21 | 23 | D |

As seen clearly from TABLE 2, the rear projection in each of Examples 1 to 8 according to the present invention had excellent light use efficiency, excellent contrast and excellent angle of view characteristics. Further, an excellent image having no diffracted light, moire and color heterogeneity could be displayed on each of the rear projections in each of Examples 1 to 8 according to the present invention. In other words, an excellent image could be displayed on each of the rear projections in each of Examples 1 to 8 according to the present invention stably. On the other hand, sufficient results could not be obtained from the rear projection in each of Comparative Examples 1 to 3 described above.

What is claimed is:

1. A method of manufacturing a microlens substrate provided with a plurality of convex lenses, the method comprising the steps of:
preparing a substrate formed of a constituent material having light transparency, a plurality of concave portions being formed in a usable area on one major surface of the substrate;
supplying a resin material having fluidity onto the one major surface of the substrate on which the plurality of concave portions have been formed;
solidifying the resin material so that an absolute index of refraction of the solidified resin material is larger than an absolute index of refraction of the constituent material of the substrate with the plurality of concave portions, thereby obtaining a base substrate with the plurality of convex lenses;
supplying a material for forming a light shielding layer onto one major surface of the base substrate opposite to the other major surface thereof which faces the substrate with the plurality of concave portions;
forming the light shielding layer on the one major surface of the base substrate by exposing the material for forming the light shielding layer via the substrate with the plurality of concave portions; and
releasing the base substrate from the substrate with the plurality of concave portions.

2. The method as claimed in claim 1, wherein, in the case where the absolute index of refraction of the solidified resin material is defined as n₁ and the absolute index of refraction of the constituent material of the substrate with the plurality of concave portions is defined as n₂, then n₁ and n₂ satisfy the relation: 0.01≦n₁/n₂≦0.8.

3. The method as claimed in claim 2, wherein the absolute index of refraction n₁ of the solidified resin material is in the range of 1.35 to 1.9.

4. The method as claimed in claim 2, wherein the absolute index of refraction n₂ of the constituent material of the substrate with the plurality of concave portions is in the range of 1.2 to 1.8.

5. The method as claimed in claim 1, wherein the substrate with the plurality of concave portions is formed of a glass material as a main material.

6. The method as claimed in claim 1, wherein the resin material solidifying step includes the steps of:
preparing a member having a flat portion; and
solidifying the resin material while pressing the resin material with the flat portion of the member.

7. The method as claimed in claim 6, wherein a plurality of spacers each having substantially the same absolute index of refraction as that of the solidified resin material are dispersed in the resin material, and in the resin material solidifying step the resin material is pressed with the flat portion of the member while the plurality of spacers are provided in the usable area on the substrate with the plurality of concave portions.

8. The method as claimed in claim 6, further comprising the step of:
providing a plurality of spacers in the usable area of the substrate with the plurality of concave portions prior to the resin material solidifying step, each of the plurality of spacers having substantially the same absolute index of refraction as that of the solidified resin material, wherein in the resin material solidifying step the resin material is pressed with the flat portion of the member in a state where the spacers are being placed in the supplied resin material.

9. The method as claimed in claim 1, wherein prior to the resin material supplying step, the one major surface of the prepared substrate with the plurality of concave portions on which the plurality of concave portions have been formed is subjected to a mold releasing process.

10. The method as claimed in claim 9, wherein the usable area of the prepared substrate with the plurality of concave portions is subjected to the mold releasing process, and at least a part of an unusable area of the prepared substrate with the plurality of concave portions other than the usable area is not subjected to the mold releasing process.

11. The method as claimed in claim 10, wherein in the base substrate releasing step the base substrate is released from the substrate with the plurality of concave portions by cutting off the unusable area of the substrate with the plurality of concave portions and/or a portion of the base substrate corresponding to the unusable area of the substrate with the plurality of concave portions.

12. The method as claimed in claim 1, wherein the plurality of convex lenses constitute microlenses, and each of the microlenses has a substantially elliptic shape when viewed from above the one major surface of the base substrate.

13. The method as claimed in claim 1, further comprising the step of:
forming a light diffusion portion formed of a material containing light diffusion media on the light shielding layer of the base substrate after the light shielding layer forming step.

14. A microlens substrate manufactured using the method defined by claim 1.

15. A transmission screen comprising:
a Fresnel lens formed with a plurality of concentric prisms on one major surface thereof, the one major surface of the Fresnel lens constituting an emission surface thereof, and
the microlens substrate defined by claim 13, the lens substrate being arranged on the side of the emission surface of the Fresnel lens.

16. A rear projection comprising the transmission screen defined by claim 15.
